(19) United States
(12) Patent Application Publication
(10) Pub. No.: US 2026/0024991 A1
(43) Pub. Date: Jan. 22, 2026

(54) METHODS AND SYSTEMS FOR FAST CORRECTION OF VOLTAGE DURING A FRACTION OF AN AC PERIOD

(71) Applicant: ARIEL SCIENTIFIC INNOVATIONS LTD., Ariel (IL)

(72) Inventors: Moshe AVERBUKH, Ariel (IL); Ido AMIEL, Ariel (IL); Zekharya DANIN, Ariel (IL)

(21) Appl. No.: 19/108,518

(22) PCT Filed: Sep. 4, 2023
(86) PCT No.: PCT/IL2023/050947

§ 371 Date: Mar. 4, 2025

Related U.S. Application Data
(60) Provisional application No. 63/403,801, filed on Sep. 5, 2022.
(60) Provisional application No. 63/403,884, filed on Sep. 6, 2022.

(51) Int. Cl. H02J 3/00; H02J 3/18

(52) U.S. Cl. CPC H02J 3/001; H02J 3/18

(57) ABSTRACT

Systems and methods for fast correction of voltage during less than a half of an AC period are presented herein. The method includes estimating during less than a half of an AC period, the RMS voltage and after recognizing the required value of voltage to be corrected correcting the voltage by calculating a required reactive power to be connected to the load to correct the voltage.

### FIELD OF THE INVENTION

The invention, in some embodiments thereof, relates to methods and systems for fast correction of voltage during a fraction of an AC period.

### BACKGROUND

In recent years, traditional voltage correction and control functionalities in electrical networks have difficulties in responding to the increasing needs for fast voltage correction, during a fraction of an AC period.

The increasingly widespread occurrences of fast-changing loads, as in, for example, the charging of electrical vehicles and the stochastic output of Photo-Voltaic (PV) generating facilities, are causing imbalances between generated and consumed power flows. The deviations in voltage cause noteworthy technical problems. Voltage control functionalities (such as tap-changers) in today's transformers are slow-reacting (i.e., takes several AC periods to correct voltage to its nominal value) and thus cannot effectively correct the imbalance.

Fast voltage correction, i.e., during a fraction of the AC period, requires dealing with several challenges. The first challenge is to estimate the Root Mean Square (RMS) voltage during the fraction of AC period. Traditionally, the RMS calculation takes a several number of AC periods due to the need to have an accurate estimation of the RMS voltage. There is a method for fast estimation of RMS voltage such as RMS estimation through signal amplitude, which is used in networks where voltage has good harmonics quality and low THD value (e.g., distribution networks). In this method instantaneous points of voltage magnitude are measured/sampled, and RMS voltage is calculated according to:

$${U}_{R M S} = \frac{{U}_{m}}{\sqrt{2}} . \qquad ( 1 )$$

However, this method's accuracy is very low.

A second challenge is to make sure the fast correction of the voltage to the required value of RMS is stable and can be effectively applied. Typically, the existed solution for fast voltage correction causes voltage instabilities in the electrical network, these instabilities are getting worse in distribution lines with simultaneous operation of photovoltaic power systems (or other additional power systems) with the local grids. These voltage fluctuations cross the allowable limits on several occasions and cause technical damages and economic losses.

There is therefore a need in the art to provide a method and system for fast correction of voltage during a fraction of an AC period, providing solutions for fast and accurate estimation of RMS voltage during a fraction of the AC period in addition to providing a stable appliance for fast correction of the voltage.

### SUMMARY

Aspects of the invention, in some embodiments thereof, relate to methods and systems for fast correction of voltage during less than a half of an AC period, in an electrical network connected to an AC voltage source, providing a voltage signal with a frequency f, and a load. The method comprises the steps of measuring and/or sampling the output voltage N points of voltage of the AC voltage signal Vᵢ, where i=1, 2 . . . N, during less than half of the AC period, each point is measured/sampled at a time tᵢ, estimating a Root Mean Square (RMS) voltage during less than a half of an AC period and correcting voltage before a next half of the AC period by calculating a required value of reactive power needed to be connected to the network to increase and/or decrease voltage in order to be in a required range of nominal values and attaching/connecting one or more reactive components with the required value of reactive power in parallel to the load before the beginning of the next half of the AC period, thereby correcting the voltage during less than a half of the AC period.

Advantageously, according to some embodiments, the methods for fast estimation of RMS voltage during less than a half of an AC period presented herein are highly accurate.

Advantageously, according to some embodiments, the method presented herein provides an accurate and efficient method for assessing the required reactive power value (capacitance or inductance) to be attached to the network before the beginning of the next half of the AC period.

According to some embodiments, the reactive power is applied at the load and generated using a capacitor bank. The capacitors are arranged in a binary order of capacitances functionality to enable a 2ⁿ equally dispersed combinations.

According to some embodiments, the proposed method can be applied together with a traditional voltage control functionality such as tap-changer facility, wherein the capacitance should be disconnected as the voltage control functionality corrects the transformation ratio.

According to some embodiments, there is provided a method for fast correction of voltage during less than a half of an AC period, in an electrical network comprising a load and connected to an AC voltage source, providing a voltage signal with a frequency f. The method comprises:
measuring and/or sampling N points of voltage of the AC voltage signal Vᵢ, where i=1, 2 . . . N, during less than half of the AC period, each point is measured/sampled at a time tᵢ;
estimating a Root Mean Square (RMS) voltage during less than a half of an AC period, comprising:
   calculating and/or estimating a correction coefficient Kc according to:

$${K}_{C} = \frac{1}{\sqrt{1 - \frac{sin ( 2 βπ )}{2 β π}}} , β = ω {t}_{m e s}$$

wherein β is a dimensionless coefficient, which is dependent on the total time measurement tₘₑₛ during which the N points are measured and/or sampled;
estimating the RMS voltage U_{RMS}, according to:

$${U}_{R M S} = {K}_{C} \cdot \sqrt{\frac{1}{N} {\sum }_{i = 1}^{N} {V}_{i}^{2}}$$

comparing the estimated RMS voltage U_{RMS} to a predetermined range of nominal values of voltage required/allowed; and
correcting voltage before a next half of the AC period by calculating a required value of reactive power needed to be connected to the electrical network to increase and/or decrease voltage in order to be in the range of nominal values required/allowed and connecting one or more reactive components with the required value of reactive power in parallel to the load before the beginning of the next half of the AC period, thereby correcting the voltage during less than a half of the AC period.

According to some embodiments, estimating the RMS voltage during less than a half of an AC period, comprises: instead of calculating Kc and U_{RMS}, fitting the measured points by representation as a sum of first k-odd sinusoidal harmonics, by applying approximation of the measured points using Least-Mean-Square approach (LMS) according to the formula:

$$S = {\sum }_{i = 1}^{k} {[ {V}_{i} - {A}_{1} sin ( ω {t}_{i} ) - {A}_{3} sin ( 3 ω {t}_{i} ) - … - {A}_{2 k - 1} sin ( ( 2 k - 1 ) ω {t}_{i} ) ]}^{2} \to MIN$$

wherein S is an approximation criterion, A₁, A₃ . . . A₂ₖ₋₁ are amplitudes of the 2k−1-odd sinusoidal harmonics of the AC signal, ω is a base angular frequency of the voltage signal, and
wherein A₁, A₃ . . . A₂ₖ₋₁ are found to fulfill the minimal value of S that is found by solving a system of K-linear algebraic equations which is represented in a matrix form as follows:

$$( \begin{matrix}{A}_{1} \\ {A}_{3} \\ ⋮ \\ {A}_{2 k - 1}\end{matrix} ) = {( \begin{matrix}{a}_{11} & {a}_{12} & … & {a}_{1 k} \\ {a}_{21} & {a}_{22} & … & {a}_{2 k} \\ … & … & … & … \\ {a}_{k 1} & {a}_{k 2} & … & {a}_{kk}\end{matrix} )}^{- 1} \cdot ( \begin{matrix}{U}_{1} \\ {U}_{2} \\ ⋮ \\ {U}_{k}\end{matrix} ) \\ where : \\ {U}_{i} = {\sum }_{i = 1}^{N} {V}_{i} sin ( ( 2 n - 1 ) \cdot ω {t}_{i} ) , n ∈ 1 , … , k \\ {a}_{l m} = {\sum }_{i = 1}^{N} sin ( ( 2 l - 1 ) \cdot ω {t}_{i} ) \cdot sin ( ( 2 m - 1 ) \cdot ω {t}_{i} ) , l , m ∈ 1 , … , k$$

According to some embodiments, estimating the RMS voltage during less than a half of an AC period, comprises:
instead of calculating Kc and

$${U}_{R M S} = {K}_{C} \cdot \sqrt{\frac{1}{N} {\sum }_{i = 1}^{N} {V}_{i}^{2}} ,$$

storing the Vi values of the N sampled pointes representing any half of the entire AC period in a stack with the same N places;
estimating the RMS voltage according to:

$${U}_{R M S} = \sqrt{\frac{1}{N} ( {\sum }_{i = 1}^{N} {V}_{i}^{2} )} ;$$

sampling and acquiring new voltage points;
storing each newly acquired voltage point in the stack;
managing the stack such that for each newly stored voltage point, the first of oldest stored voltage point in the stack is removed such that the total number of measured points in the stack remains constant and equal to N; and
for each new sampled voltage point, estimating the RMS voltage value with the new sampled voltage point, according to

$${U}_{R M S} = \sqrt{\frac{1}{N} ( {\sum }_{i = 1}^{N} {V}_{i}^{2} )} .$$

According to some embodiments, the N points are equidistantly dispersed points of voltage Vi magnitudes during less than half of the AC period.

According to some embodiments, N≥100 points.

According to some embodiments, the electrical network is connected to a transmission and/or distribution line and is represented by an equivalent circuit which is connected to a voltage source providing a voltage signal Vs, and where a resistance R1 and a reactance X1 of the distribution line are connected in parallel and a resistance R2 and a reactance X2 of the load are connected in parallel;
wherein

$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} ;$$

and
wherein a voltage magnification coefficient is defined as

$$λ r = {( \frac{Vo}{Vs} )}^{2} and χ = \frac{{V}_{o}}{{V}_{S}} ,$$

where Vo is an output voltage.

According to some embodiments, correcting voltage comprises:
estimating a required capacitance to be connected in parallel to the load, according to:

$$C = \frac{Yc}{ω}$$

wherein

$$Yc = \frac{1}{Xc}$$

and Xc is the reactance of the capacitance required to be connected, and ω is the base angular frequency of the voltage signal; and
connecting n capacitors in parallel to the load to provide the required capacitance C.

According to some embodiments, estimating a required capacitance, further comprising estimating a capacitance which brings to a maximal voltage increase, to be connected in parallel to the load, according to:

$${C}_{vmax} = \frac{{Y}_{1} + {Y}_{2}}{ω} .$$

Thereby providing information regarding the maximal voltage increase allowed.

According to some embodiments, one or more additional power sources are connected to the electrical network for providing a supplementary electrical power P where

$${G}_{P} = \frac{P}{{V}_{S}^{2}} ,$$

and wherein P is sampled every m seconds, thereby allowing calculating Vs the resistance R2 and the reactance X2 of the load.

According to some embodiments, correcting the voltage comprising:
defining a parameter ρ, wherein

$$ρ = \frac{[ {( {G}_{1} + {G}_{2} )}^{2} + {( {Y}_{1} + {Y}_{2} − {Y}_{C} )}^{2} ]}{( {G}_{1} + {G}_{2} ) {G}_{P} + 0.5 ( {G}_{1}^{2} + {Y}_{1}^{2} )} ,$$

and ρ>1;
determining parameter ρ according to the required voltage correction;
defining a parameter α wherein

$$α = \frac{{G}_{P}^{2}}{[ ( {G}_{1} + {G}_{2} ) {G}_{P} + 0.5 ( {G}_{1}^{2} + {Y}_{1}^{2} ) ]} ;$$

and
calculating α according to the determined ρ parameter.

According to some embodiments, the additional power sources are Photo Voltaic (PV) stations, wind turbines, generators.

According to some embodiments, the current of additional power source is calculated according to:

$$Is = \sqrt{{( \frac{χ V s}{R 2} - \frac{P}{χ V s} )}^{2} + {{V s}^{2} ( \frac{χ}{X 1} - \frac{χ}{Xc} )}^{2}}$$

where Vs is the voltage of the AC voltage source, R₂ is the resistance of the load, P is the supplementary electrical power of the one or more additional power sources, V₀ is the output voltage,

$$χ = \frac{V o}{V s}$$

and Xc is the reactance of a capacitance C connected to the load in parallel.

According to some embodiments, a voltage control functionality is integrated into the electrical network to facilitate gradual voltage correction over a specified number of AC periods up to a moment the voltage returns to the nominal range of values, wherein correcting voltage further comprises:
upon correcting the voltage by the voltage control functionality, estimating required C and decreasing the capacitance accordingly, by disconnecting one or more capacitors from the n capacitors;
repeatedly estimating C as the voltage control functionality corrects the voltage and repeatedly decreasing the capacitance accordingly, by disconnecting one or more capacitors from the n capacitors, until the required capacitance is C=0 and all n capacitors are disconnected.

According to some embodiments, the capacitors are connected to the load for about 40-150 seconds, thereby allowing the voltage control functionality to fully correct the voltage such that no capacitance is required to be connected to the load.

According to some embodiments, the capacitors are connected at the beginning or end of a voltage AC period.

According to some embodiments, the capacitors are connected and/or disconnected with switches.

According to some embodiments, when correcting the voltage, connecting one or more capacitors to the load for increasing the voltage or connecting one or more inductors to the load for decreasing the voltage.

According to some embodiments, correcting voltage comprising:
estimating a required inductance to be connected in parallel to the load, according to:

$${L}_{c o i l} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} \frac{1}{{X}_{2}} ]} ,$$

wherein one or more additional power sources are connected to the electrical network for providing a supplementary electrical power P and wherein

$${G}_{P} = \frac{P}{{V}_{S}^{2}} ;$$

wherein

$$ρ = \frac{[ {( {G}_{1} + {G}_{2} )}^{2} + {( {Y}_{1} + {Y}_{2} − {Y}_{C} )}^{2} ]}{( {G}_{1} + {G}_{2} ) {G}_{P} + 0.5 ( {G}_{1}^{2} + {Y}_{1}^{2} )}$$

connecting 1 inductors in parallel to the load to provide the required inductance Lcoil.

According to some embodiments, a voltage control functionality is integrated into the electrical network to facilitate gradual voltage correction over a specified number of AC periods up to a moment the voltage returns to the nominal range of values, wherein correcting voltage further comprises:
upon correcting the voltage by the voltage control functionality, estimating required Lcoil and decreasing the inductance accordingly, by disconnecting one or more inductors from the 1 inductors;
repeatedly estimating Lcoil as the tap changer corrects the voltage and repeatedly decreasing the inductance accordingly, by disconnecting one or more inductors from the 1 inductors, until the required inductance is Lcoil=0 and all 1 inductors are disconnected.

According to some embodiments, the inductors are connected to the load for about 40-150 seconds, thereby allowing the voltage control functionality to fully correct the voltage such that no inductance is required to be connected to the load.

According to some embodiments, the inductors are connected at the beginning or end of a voltage AC period.

According to some embodiments, the inductors are connected and/or disconnected with switches.

According to some embodiments, a system for fast correction of voltage during less than a half of an AC period is presented herein. The system comprises:

An AC voltage source providing a voltage signal with a frequency f;
a voltage transducer for translating instantaneous network voltage magnitudes to low-voltage signal of up to 50 Volts;
an analog to digital converter (A/D) receiving input signals from the voltage transducer and outputs digital signals; and
a controller receiving the digital signals from the A/D, configured to:
   measure and/or sample N points of voltage Vi of the AC voltage signal, during less than half of the AC period, each point is measured/sampled at a time tᵢ, where i=1 . . . N;
   estimate a Root Mean Square (RMS) voltage during less than a half of an AC period, comprising:
      calculate/estimate a correction coefficient Kc according to:

$${K}_{C} = \frac{1}{\sqrt{1 - \frac{sin ( 2 β π )}{2 β π}}} , β = ω {t}_{m e s}$$

wherein β is a dimensionless coefficient, which is dependent on the total time measurement tₘₑₛ during which the N points are measured;
estimate the RMS voltage U_{RMS}, according to:

$${U}_{R M S} = {K}_{C} \cdot \sqrt{\frac{1}{N} {\sum }_{i = 1}^{N} {V}_{i}^{2}}$$

compare the estimated RMS voltage U_{RMS} to a predetermined range of values of voltage required/allowed; and
correct voltage before a next half of the AC period by calculating a required value of reactive power needed to be connected to the network to increase and/or decrease voltage in order to be in the range of nominal values required/allowed, and connecting one or more reactive components with the required value of reactive power in parallel to the load before the beginning of the next half of the AC period, thereby correcting the voltage during less than a half of the AC period.

According to some embodiments, the controller is configured to:
fit the measured points by representation as a sum of first k-odd sinusoidal harmonics, by applying approximation of the measured points using Least-Mean-Square approach (LMS) according to the formula:

$$S = {\sum }_{i = 1}^{k} {[ {V}_{i} - {A}_{1} sin ( ω {t}_{i} ) - {A}_{3} sin ( 3 ω {t}_{i} ) - … - {A}_{2 k - 1} sin ( ( 2 k - 1 ) ω {t}_{i} ) ]}^{2} \to MIN$$

wherein S is an approximation criterion, A1, A3 . . . A₂ₖ₋₁ are amplitudes of the 2k−1-odd sinusoidal harmonics of the AC signal, ω is a base angular frequency of the voltage signal, and tᵢ is the time difference between two adjacent voltage measurements, and
wherein A1, A3 . . . A2k−1 are found to fulfill the minimal value of S that is found by solving a system of K-linear algebraic equations which can be represented in the matrix form as follows:

$$( \begin{matrix}{A}_{1} \\ {A}_{3} \\ ⋮ \\ {A}_{2 k − 1}\end{matrix} ) = {( \begin{matrix}{a}_{11} & {a}_{12} & ⋯ & {a}_{1 k} \\ {a}_{21} & {a}_{22} & ⋯ & {a}_{2 k} \\ ⋯ & ⋯ & ⋯ & ⋯ \\ {a}_{k 1} & {a}_{k 2} & ⋯ & {a}_{k k}\end{matrix} )}^{− 1} \cdot ( \begin{matrix}{U}_{1} \\ {U}_{2} \\ ⋮ \\ {U}_{k}\end{matrix} )$$

$$where :$$

$${U}_{i} = {\sum }_{i = 1}^{N} {V}_{i} sin ( ( 2 n - 1 ) \cdot ω {t}_{i} ) , n ∈ 1 , … , k$$

$${a}_{l m} = {\sum }_{i = 1}^{N} sin ( ( 2 l - 1 ) \cdot ω {t}_{i} ) \cdot sin ( ( 2 m - 1 ) \cdot ω {t}_{i} ) ,$$

$$l , m ∈ 1 , … , k .$$

According to some embodiments, the controller is configured to:
store the Vi values of the N sampled pointes representing each half of the entire AC period in a stack with the same N places;
estimate the RMS voltage according to:

$${U}_{R M S} = \sqrt{\frac{1}{N} ( {\sum }_{i = 1}^{N} {V}_{i}^{2} )} ;$$

sample and acquiring new voltage points;
store each newly acquired voltage point in the stack;
manage the storage stack such that for each newly stored voltage data point, the first of oldest stored voltage point in the stack is removed such that the total number of measured points in the stack remains constant and equal to N; and
for each new sampled point, estimate the RMS voltage value with the new sampled voltage point, according to

$${U}_{R M S} = \sqrt{\frac{1}{N} ( {\sum }_{i = 1}^{N} {V}_{i}^{2} )} .$$

According to some embodiments, the electrical network is connected to a transmission and/or distribution line and is represented by an equivalent circuit which is connected to a voltage source providing a voltage signal Vs, and where a resistance R1 and a reactance X1 of the distribution line are connected in parallel and a resistance R2 and a reactance X2 of the load are connected in parallel;
wherein

$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} ;$$

and
wherein a voltage magnification coefficient is defined as

$$λ r = {( \frac{V o}{V s} )}^{2}$$

$$and$$

$$χ = \frac{{V}_{o}}{{V}_{s}} ,$$

where Vo is an output voltage.

According to some embodiments, the controller is configured to:
estimating a required capacitance to be connected in parallel to the load, according to:

$$C = \frac{{Y}_{C}}{ω}$$

wherein

$$Yc = \frac{1}{Xc}$$

and Xc is the reactance of the capacitance required to be connected, and ω is the base angular frequency of the voltage signal; and
connecting n capacitors in parallel to the load to provide the required optimal capacitance C.

According to some embodiments, the controller is further configured to: estimate a required capacitance which brings to a maximal voltage increase, to be connected in parallel to the load, according to:

$${C}_{vmav} = \frac{{Y}_{1} + {Y}_{2}}{ω} ,$$

thereby providing information regarding the maximal voltage increase allowed.

According to some embodiments, the electrical network further comprising one or more additional power sources connected to the electrical network for providing a supplementary electrical power P where

$${G}_{P} = \frac{P}{{V}_{S}^{2}} ,$$

wherein P is sampled every m seconds, thereby allowing calculating the resistance R2 and the reactance X2 of the load.

According to some embodiments, the controller is further configured to correct the voltage, by:
defining a parameter ρ, wherein

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} ,$$

and ρ>1;
determining parameter ρ according to the required voltage correction;
defining α parameter α wherein

$$α = \frac{{G}_{P}^{2}}{[ ( {G}_{1} + {G}_{2} ) {G}_{P} + 0.5 ( {G}_{1}^{2} + {Y}_{1}^{2} ) ]} ;$$

and
calculating α according to the determined ρ parameter.

According to some embodiments, the system further comprising a voltage control functionality to facilitate correct the voltage gradually over a specified number of AC periods up to a moment the voltage returns at its nominal value, and wherein the controller is configured to:
upon correcting the voltage by the voltage control functionality, estimating required C and decreasing the capacitance accordingly, by disconnecting one or more capacitors from the n capacitors;
repeatedly estimating C as the voltage control functionality corrects the voltage and repeatedly decreasing the capacitance accordingly, by disconnecting one or more capacitors from the n capacitors, until the required capacitance is C=0 and all n capacitors are disconnected.

According to some embodiments, the capacitors are connected and/or disconnected with switches.

According to some embodiments, the controller is configured to correct the voltage by connecting one or more capacitors to the load for increasing the voltage or connecting one or more inductors to the load for decreasing the voltage.

According to some embodiments, the controller is further configured to correct voltage by:
estimating a required inductance to be connected in parallel to the load, according to:

$${L}_{coil} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} \frac{1}{{X}_{2}} ]} ,$$

wherein one or more additional power sources are connected to the electrical
network for providing a supplementary electrical power P and wherein

$${G}_{P} = \frac{P}{{V}_{S}^{2}} ;$$

wherein

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$

and ρ<1;
connecting 1 inductors in parallel to the load to provide the required inductance Lcoil.

According to some embodiments, further comprising a voltage control functionality integrated into the electrical network to facilitate gradual voltage correction over a specified number of AC periods up to a moment the voltage returns at its nominal value, wherein correcting voltage further comprises:
upon correcting the voltage by the voltage control functionality, estimating required Lcoil and increasing the inductance accordingly, by disconnecting one or more inductors from the 1 inductors;
repeatedly estimating Lcoil as the tap changer corrects the voltage and repeatedly increasing the inductance accordingly, by disconnecting one or more inductors from the 1 inductors, until the required inductance is Lcoil=0 and all 1 inductors are disconnected.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 schematically shows a diagram of a system for fast correction of voltage during less than a half of an AC period, according to some embodiments;

FIG. 2 schematically shows a graph of the correction coefficient Kc vs R value, according to some embodiments;

FIG. 3 schematically shows an example of a system for fast correction of voltage during half than an AC period, in an electrical network 106 connected to an AC voltage providing a voltage signal, according to some embodiments;

FIG. 4schematically show an equivalent circuit of the distribution line, according to some embodiments;

FIG. 5 schematically shows relative voltage changes vs capacitance of the load, when the capacitor/s are connected with the load, according to some embodiments;

FIG. 6 schematically shows a flowchart of a method for fast correction of voltage during less than a half of an AC period, in an electrical network connected to an AC voltage providing a voltage signal, according to some embodiments;

FIG. 7 schematically shows a flowchart of a method for correcting voltage by estimating a required conductance C and connecting the same in parallel to the load, according to some embodiments;

FIG. 8 schematically shows relative enhancement of load voltage and source current as a function of capacitance increases for PV power of 0% and 30%, according to some embodiments;

FIG. 9 schematically shows a flowchart of a method for correcting voltage by estimating a required inductance Lcoil and connecting the same in parallel to the load, according to some embodiments;

FIG. 10A schematically shows a relative error histogram for sampling time of 5 ms, according to some embodiments;

FIG. 10B schematically shows a relative error histogram for sampling time of 7 ms, according to some embodiments;

FIG. 10C schematically shows a relative error histogram for sampling time of 9 ms, according to some embodiments;

FIG. 11 schematically shows the Root Mean Square (RMS) Error with its standard deviation (STD) for the method of estimating RMS voltage with a correction coefficient Kc, according to some embodiments;

FIG. 12A schematically shows a relative RMS error histogram for one-harmonic estimation with sampling time of 5 ms, according to some embodiments;

FIG. 12B schematically shows a relative RMS error histogram for one-harmonic estimation with sampling time of 7 ms, according to some embodiments;

FIG. 12C schematically shows a relative RMS error histogram for one-harmonic estimation with sampling time of 9 ms, according to some embodiments;

FIG. 13 schematically shows the average relative RMS error for one-two, and three-harmonics representations, according to some embodiments;

FIG. 14 schematically shows a simulated circuit of the voltage control system carried out using PSIM software to correct voltage by connecting and disconnecting capacitors, according to some embodiments;

FIG. 15 schematically shows an equivalent circuit using for the experiment of correction of voltage by estimating required capacitance and connecting and disconnecting capacitors, according to some embodiments;

FIGS. 16A-16C schematically presents the output of the control system simulation of the experiment of correction of voltage by estimating required capacitance and connecting and disconnecting capacitors, according to some embodiments;

FIGS. 17A-17B schematically present theoretical and experimental data of relative voltage and current changes versus capacitance value, according to some embodiments;

FIG. 18 schematically present the relative changes in the source current followed by a voltage increase, according to some embodiments; and

FIGS. 19A-19B schematically show voltage and current dynamic response as a function of time, during capacitor switching, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, each of the words “comprise” “include” and “have”, and forms thereof, are not necessarily limited to members in a list with which the words may be associated.

As used herein, the term “electrical network” and “grid” may interchangeably be used.

According to some embodiments, there are provided advantageous systems and methods for fast correction of voltage during less than a half of an AC period, in an electrical network connected to an AC voltage providing a voltage signal. According to some embodiments, the system includes an AC voltage source providing a voltage signal, a voltage transducer which translates instantaneous network voltage magnitudes to low-voltage signal a of up to 50 Volts, an analog to digital converter (A/D) for converting analog input signals from the voltage transducer and into digital signals and a controller which receives the digital signals from the A/D. According to some embodiments, the controller is configured to measure and/or sample N points of voltage Vi of AC voltage signal, during less than half of the AC period, and to estimate a Root Mean Square (RMS) voltage during less than a half of an AC period, yet, keeping a high level of accuracy of the estimated RMS voltage. According to some embodiments, the controller is configured to estimate the RMS voltage during less than a half of an AC period in three different ways. According to some embodiments, in one option the controller is configured to calculate/estimate a correction coefficient Kc and, to estimate the RMS voltage taking into account the correction coefficient Kc. According to some embodiments, in a second option, the controller is configured fit the measured points by representation as a sum of first k-odd sinusoidal harmonics, by applying approximation of the measured points using Least-Mean-Square approach (LMS). According to some embodiments, in a third option, the controller is configured to store the Vi values of the N sampled pointes representing any half of the entire AC period in a stack with the same N places and estimate the RMS voltage of the N points. The controller is configured to repeatedly sample and acquire new voltage points and store each newly acquired voltage point in the stack, such that the first oldest stored voltage point in the stack is removed such that the total number of measured points in the stack remains constant and equal to N. For each new sampled point, the controller is configured to estimate the RMS voltage value with the new sampled voltage point. Advantageously, each one of the three options for fast estimation of the RMS voltage during less than a half of an AC period is highly accurate in addition to being fast, therefore application which require high accuracy degree may use the presented options.

According to some embodiments, once the controller estimates the RMS voltage value during less than a half of an AC period, the controller is configured to compare the estimated value of RMS voltage to a predetermined range of values of voltage required/allowed (i.e., nominal value/s), to assess the needed correction of voltage. According to some embodiments, the controller is configured to correct voltage before a next half of the AC period by calculating a required value of reactive power needed to be connected to the electrical network to increase and/or decrease voltage in order to be in the required range of nominal values and attaching/connecting one or more reactive components with the required value of reactive power in parallel to the load before the beginning of the next half of the AC period, thereby correcting the voltage during less than a half of the AC period.

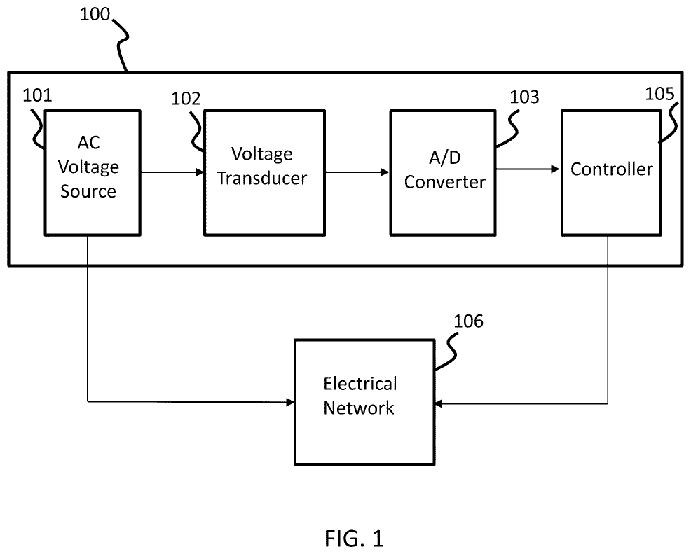

Reference is now made to FIG. 1 which schematically shows a diagram of a system 100 for fast correction of voltage in an electrical network 106, during less than a half of an AC period, according to some embodiments. System 100 includes an AC voltage source 101, a voltage transducer 102, an analog to digital converter (A/D) 103 and a controller 105. AC voltage source 101 provides a voltage signal with a frequency f. According to some embodiments, Ac voltage source 101 may be a part of the electrical network 106, and not a part of system 100, however, in this case system 100 is connected to the AC voltage source as part of the electrical network, for example when the electrical network is a national electrical grid or part of the national electrical grid, the AC voltage source is provided by the electrical network. According to some embodiments, voltage transducer 102 translates instantaneous network voltage magnitudes to low-voltage signal of up to 50 Volts. A/D 103 receives input signals from voltage transducer 102 and outputs digital signals, and controller 105 receives the digital signals from A/D 103. According to some embodiments, controller 105 is configured to measure and/or sample N points of voltage Vi of AC voltage signal 101, during less than half of the AC period, each point is measured/sampled at a time tᵢ, where i=1 . . . N. Controller 105 is configured to estimate a Root Mean Square (RMS) voltage during less than a half of an AC period.

According to some embodiments, in a first option, controller 105 is configured to calculate/estimate a correction coefficient Kc according to the following formulas:

$${K}_{C} = \frac{1}{\sqrt{1 - \frac{sin ( 2 β π )}{2 β π}}} , \qquad ( 2 )$$

$$β = ω {t}_{mes} \qquad ( 3 )$$

wherein β is a dimensionless coefficient, which is dependent on the total time measurement tₘₑₛ during which the N points are measured, and ω is the angular frequency (ω=2πf).

After the correction coefficient is found, controller 105 is configured to estimate the RMS voltage U_{RMS}, according to:

$${U}_{R M S} = {K}_{C} \cdot \sqrt{\frac{1}{N} {\sum }_{i = 1}^{N} {V}_{i}^{2}} . \qquad ( 4 )$$

According to some embodiments, the correction coefficient Kc is developed as follows: starting with the rigorous math determination of RMS voltage, for N equidistantly dispersed points of a voltage magnitude obtained during an integer number of AC periods:

$${U}_{R M S} = \sqrt{\frac{1}{N} ( {\sum }_{i = 1}^{N} {U}_{i}^{2} )} . \qquad ( 5 )$$

If the measured points of instantaneous voltage values were obtained during a fraction of an AC period only, the application of expression (5) leads to a rough error and is not applicable. For the correct RMS estimation expression (5) should be modified.

For an AC frequency of f=50 Hz, the time of voltage measurements should be not less than 5 ms to overcome sinus amplitude. Owing to the requirements of a voltage correction during the half of an AC period, the measurement time cannot be more than 6-7 ms maximum. The remaining 3-4 ms to the half (10 ms) of the AC period (an AC period for 50 Hz is 20 ms) are needed for controller 105 to evaluate a situation and to decide which reactive power (capacitive or inductive) is required to correct voltage. If the RMS voltage value lies between permissible levels (+/−10% of its rated magnitude) controller 105 does not introduce reactive power into the electrical network 106.

Assuming the measurement time is from 5 ms to 10 ms (i.e., tₘₑₛ=5 ms). The time is represented by the angle (07r) where 7L is half of the period and p is dimensionless coefficient. The expression for RMS estimation is then:

$${U}_{R M S}^{*} = \sqrt{\frac{1}{ω θ} {\int }_{0}^{θ} {V}_{m}^{2} {sin}^{2} ( ω t ) d ( ω t )} \qquad ( 6 )$$

After simplification and substitution (βπ) instead of variable θ:

$${U}_{R M S}^{*} = \frac{{V}_{m}}{\sqrt{2}} \sqrt{1 - \frac{sin ( 2 β π )}{2 β π}} \qquad ( 7 )$$

For voltage

$${U}_{R M S}^{*}$$

of equation (7) to be equal to the real RMS value that can be expressed as

$${U}_{R M S} = \frac{{V}_{m}}{\sqrt{2}}$$

it must be multiplied by the correction coefficient K_{C} equal to:

$${K}_{C} = \frac{1}{\sqrt{1 - \frac{sin ( 2 β π )}{2 β π}}} , {U}_{R M S} = {U}_{R M S}^{*} \cdot {K}_{C} \qquad ( 8 )$$

The dimensionless coefficient β value is the derivative of measuring time tₘₑₛ:

$$β = ω {t}_{mes} for for any ω \qquad ( 9 )$$

For example, for AC frequency of 50 Hz the received p is:

$$β = π \frac{{t}_{mes}}{10 ms} .$$

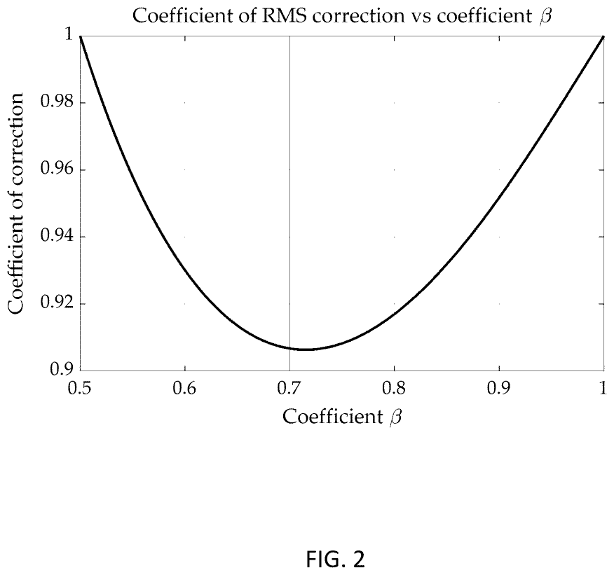

FIG. 2 schematically shows a graph of the correction coefficient Kc vs R value, according to some embodiments.

According to some embodiments, the N points are sampled during ¼ to ½ of an AC period.

According to some embodiments, controller 105, is configured to compare the estimated RMS voltage U_{RMS} to a predetermined range of values of voltage required/allowed (i.e., to range of nominal values), and correct voltage before a next half of the AC period by calculating a required value of reactive power needed to be connected to the electrical network 106 to increase and/or decrease voltage in order to be in the required/allowed range of values, and attaching/connecting one or more reactive components with the required value of reactive power in parallel to the load before the beginning of the next half of the AC period, thereby correcting the voltage of the electrical network 106 during less than a half of the AC period.

According to some embodiments, in a second option, controller 105 is configured to estimate the RMS voltage by fitting the measured/sampled points with trigonometric functions representing voltage harmonics. According to some embodiments, controller 105 is configured to fit the measured points by representation as a sum of first k-odd sinusoidal harmonics, by applying approximation of the measured points using Least-Mean-Square approach (LMS).

According to some embodiments, to estimate RMS voltage by fitting the measured points with trigonometric functions representing voltage harmonics it is enough to obtain harmonics amplitudes and further, to RMS as:

$${U}_{R M S} = \frac{1}{\sqrt{2}} \sqrt{{\sum }_{i = 1}^{k} {( {U}_{m} )}_{i}^{2}} \qquad ( 10 )$$

For approximation of measured points, a Least-Mean-Square approach (LMS) is applied:

$$S = {{\sum }_{i = 1}^{k} [ {V}_{i} - {A}_{1} sin ( ω {t}_{i} ) - {A}_{3} sin ( 3 ω {t}_{i} ) - … - {A}_{2 k - 1} sin ( ( 2 k - 1 ) ω {t}_{i} ) ]}^{2} \to MIN \qquad ( 11 )$$

Where: S denotes the criterion of approximation, Vi denoted the i-measured instantaneous voltages (from the set of N-voltage points) obtained in a ti moment of a time, A₁-A₂ₖ₋₁ denotes amplitudes of harmonics, and co denotes the base angular frequency of the voltage signal.

To get a minimum of the criterion S all partial derivatives dS/dAi are equalized to zero:

$$( \begin{matrix}\begin{matrix}\frac{\partial S}{\partial {A}_{1}} = {\sum }_{i = 1}^{k} sin ( ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ;\end{matrix} \\ \frac{\partial S}{\partial {A}_{n}} = {\sum }_{i = 1}^{k} sin ( ( 2 k - 1 ) ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ; \\ \frac{\partial S}{\partial {A}_{1}} = {\sum }_{i = 1}^{k} sin ( ( 2 k - 1 ) ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ;\end{matrix} ) \qquad ( 13 )$$

This set of equations represents a system of k-linear algebraic equations which can be solved in a matrix form as follows:

$$( \begin{matrix}{A}_{1} \\ {A}_{3} \\ ⋮ \\ {A}_{2 k - 1}\end{matrix} ) = {( \begin{matrix}{a}_{11} & {a}_{12} & ⋯ & {a}_{1 k} \\ {a}_{21} & {a}_{22} & ⋯ & {a}_{2 k} \\ ⋯ & ⋯ & ⋯ & ⋯ \\ {a}_{k 1} & {a}_{k 2} & ⋯ & {a}_{kk}\end{matrix} )}^{- 1} \cdot ( \begin{matrix}{U}_{1} \\ {U}_{2} \\ ⋮ \\ {U}_{k}\end{matrix} ) \\ where : \qquad ( l4 )$$

$${U}_{i} = {\sum }_{i = 1}^{N} {V}_{i} sin ( ( 2 n - 1 ) \cdot ω {t}_{i} ) , n ∈ 1 , … , k \qquad ( 15 )$$

$${a}_{l m} = {\sum }_{t = 1}^{N} sin ( ( 2 l - 1 ) \cdot ω {t}_{t} ) \cdot sin ( ( 2 m - 1 ) \cdot {ω t}_{t} ) , l , n ∈ 1 , … , k \qquad ( 16 )$$

According to some embodiments, a traditional Fourier series representation may be applied, however, it is relatively heavy and less accurate compared with the fitting of the measured points with the trigonometric functions representing voltage harmonics presented herein. According to some embodiments, the description of a periodic (sinusoidal) signal by a set of harmonics that fits the obtained voltage points by the least-mean-square algorithm allows estimating the RMS voltage during less than a half of an AC period with high accuracy. This is based on solving the matrix equations. This way the need of a finding Fourier coefficient by integral calculations is prevented and the requirement for applying strong computational efforts is eliminated.

According to some embodiments the accuracy of the RMS voltage estimation by fitting the measured points with trigonometric functions representing voltage harmonics, is even more accurate than the RMS voltage estimation by estimating a correction coefficient Kc, however, it is more complicated to apply.

According to some embodiments, in a third option, controller 105 is configured to store the Vi values of the N sampled points representing any half of period out of the entire AC period in a stack with the same N places, and is configured to estimate the RMS voltage according to the formula:

$${U}_{R M S} = \sqrt{\frac{1}{N} ( {\sum }_{i = 1}^{N} {V}_{i}^{2} )} . \qquad ( 17 )$$

According to some embodiments, controller 105 is configured to sample and acquire new voltage points and store each newly acquired voltage point in the storage stack. According to some embodiments, controller 105 is configured to manage the storage stack such that for each newly stored voltage point, the first of oldest stored voltage point in the stack is removed such that the total number of the measured points in the stack remains constant and equal to N. For each new sampled point, the controller is configured to estimate the RMS voltage value taking into consideration the new sample, according to

$${U}_{R M S} = \sqrt{\frac{1}{N} ( {\sum }_{i = 1}^{N} {V}_{i}^{2} )} ,$$

where the value of V_{(i=N)} is the value of the new sample.

Advantageously, estimating the RMS voltage by keeping sampling the voltage signal and calculating U_{RMS} is very highly accurate, very fast and it is easy to apply and does not require high computational resources.

According to some embodiments, controller 105 is configured to correct the voltage before a next half of the AC period. According to some embodiments, controller 105 is configured to calculate a required value of reactive power needed to be connected to the electrical network 106 to increase and/or decrease voltage in order to be in the required/allowed (nominal) range of values, and attaching/connecting one or more reactive components with the required value of reactive power in parallel to the load before the beginning of the next half of the AC period, thereby correcting the voltage during less than a half of the AC period. According to some embodiments the reactive components may be one or more capacitors or one or more inductors, depending on the correction of voltage that has to done. According to some embodiments, when the voltage needs to be increased, one or more capacitors are attached to the electrical network 106. According to some other embodiments, when the voltage needs to be decreased, one or more inductors are attached to the electrical network 106.

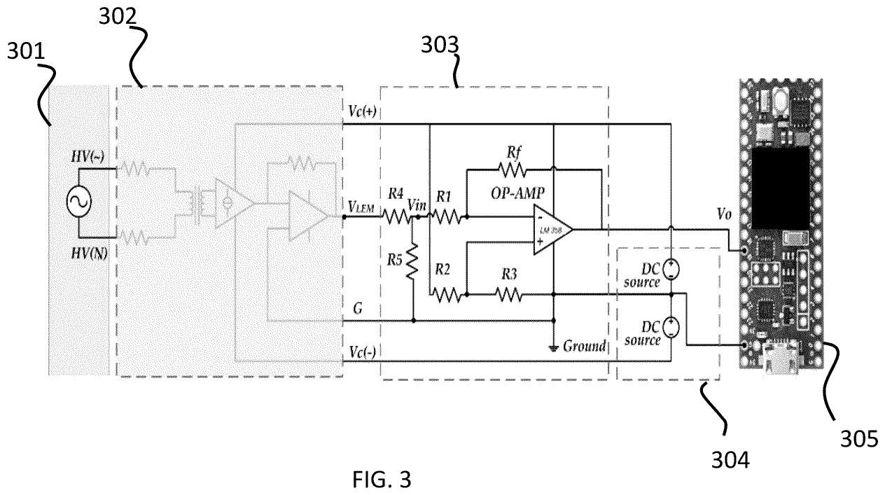

FIG. 3 schematically shows an example of a system for fast correction of voltage during half than an AC period, in an electrical network 106 connected to an AC voltage providing a voltage signal, according to some embodiments. System 300 includes a laboratory AC voltage source DRTS 33 301, which is able to simulate real AC voltage with an arbitrary harmonic content. A voltage transducer CV 3-500, 302 translating high instantaneous network 106 voltage amplitudes (in the size of 10-33 kV and more) to low-voltage signal (up to 50V). An analog converter AC to DC, 303 for scaling and shifting output voltage of the transducer 302 to an analog A/D converter 304, and a Teensy 4.1 controller 305 which receives as an input the digital signal outputted from the A/D converter. The resistive components in the analog converter have the following magnitudes: R1=15.54KΩ, R2=15.32KΩ, R3=1KΩ, and Rf=9.88KΩ.

According to some embodiments, in this example, controller 305 translates analog signal to digital information and estimate voltage RMS each 6-7 msec comparing it to the nominal value. According to some embodiments, controller 305 decides which reactive power value should be introduced to the load when voltage level had overcome permissible boundaries. Moreover, controller 305 calculates a required capacitance, determine the capacitors in a bank of capacitors are suitable to be connected to a load and send signals to appropriate Silicon Controller Rectifier (SCR) drivers which are responsible to connecting/disconnecting specific capacitors. According to some embodiments, in this example, as part of the laboratory equipment for supervising the experimental process and accepting decisions a digital A/D 10-bit transducer was used, digitizing 2000 uniformly distributed magnitudes per one period of AC signal and acquiring data in the built-in memory.

According to some embodiments, the electrical network 106 includes a transmission line and/or distribution line and a load, where a resistance r1 and a reactance x1 of the distribution line are connected in serial and a resistance r2 a reactance x2 of the load, are connected in serial.

According to some embodiments, the electrical network 106 may include a distribution line and load and may be represented by an equivalent circuit which is connected to the voltage source, providing a voltage signal Vs, and where a resistance R1 and a reactance X1 of the distribution line are connected in parallel and a resistance R2 and a reactance X2 of the load are connected in parallel.

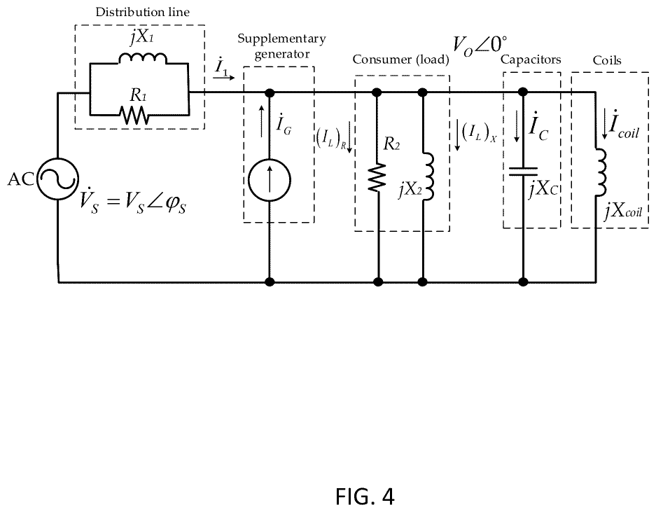

FIG. 4 schematically shows an equivalent circuit of the distribution line where the resistance R₁ and a reactance X₁ of the distribution line are connected in parallel and a resistance R₂ and a reactance X₂ of the load are connected in parallel, according to some embodiments. According to some embodiments, optionally, a supplementary power source 301 may also be connected to the electrical network 106. According to some embodiments the supplementary power source may be a Photo Voltaic (PV) plant, a wind turbine, a generator and the like. As can be seen in FIG. 4, current I₁ is the current of the distribution line, current I_{G} is the current of the supplementary power source and I(_{L})_{R} is the current of the resistance of the load and I(_{L})_{X} is the current of the reactance of the load. X_{C} and X_{coil} represent the capacitive reactance of capacitor's bank and the reactance of the coil needed for voltage correction. I_{C} and I_{coil} represent the current of the capacitor(s) and the current of the corrective coil respectively. According to some embodiments, the following parameters are defined:

$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} ; {Y}_{C} = \frac{1}{{X}_{C}} , \qquad ( 18 )$$

and a voltage magnification coefficient is defined as

$$λ r = {( \frac{Vo}{Vs} )}^{2} and χ = \frac{Vo}{Vs} ,$$

where Vo is an output voltage.
The nodal circuit approach provides the following equation:

$$\frac{{\dot{V}}_{S} - Vo}{{jX}_{1}} + \frac{{\dot{V}}_{S} - Vo}{{R}_{1}} + {I}_{pv} - \frac{Vo}{{R}_{2}} - \frac{Vo}{{jX}_{2}} - \frac{Vo}{- {jX}_{C}} = 0 \qquad ( 19 )$$

where \dot{V}_{S} is the output transformer voltage, which is designated as source voltage phasor, and Vo is load voltage.
For simplicity, the load voltage Vo identifies as a complex number with the phase angle equal to zero; therefore, it can be represented as a real number. As a result, the current of a PV source can be simply estimated as Ipv=P VO. Equation (19) can be written as:

$$\frac{{\dot{V}}_{S} - V}{{jX}_{1}} + \frac{{\dot{V}}_{S} - V}{{R}_{1}} + \frac{P}{Vo} - \frac{Vo}{{R}_{2}} + j \frac{Vo}{{X}_{2}} - j \frac{Vo}{{X}_{C}} = 0 \qquad ( 20 )$$

Source voltage phasor can be represented as:

$${\dot{V}}_{S} = {V}_{S} cos φ + {jV}_{S} sin φ \qquad ( 21 )$$

After setting the defined parameters the following form is received:

$${V}_{S} ( cos φ + j sin φ ) ( {G}_{1} - {jY}_{1} ) + Vo ( {jY}_{1} + {jY}_{2} - j ω C - {G}_{1} - {G}_{2} ) + \frac{P}{Vo} = 0 \qquad ( 22 )$$

After simplification, the real and imaginary parts of this equation is expressed as:

$${χ}^{2} ( {G}_{1} + {G}_{2} ) - χ ( {G}_{1} cos φ + {Y}_{1} sin φ ) - {G}_{P} = 0 \qquad ( 23 )$$

$$χ ( {Y}_{1} + {Y}_{2} - Yc ) + ( {G}_{1} sin φ - {Y}_{1} cos φ ) = 0 \qquad ( 24 )$$

where

$${G}_{P} = \frac{P}{{V}_{S}^{2}} .$$

Variable χ is termed as a load voltage magnification effect. During voltage instabilities, the required magnitude of χ should be ensured by a special selection of the capacitance or inductance.

### Defining:

$${G}_{1} sin φ - {Y}_{1} cos φ = A$$

$$and$$

$${G}_{1} cos φ + {Y}_{1} sin φ = B$$

The following form is received:

$${A}^{2} + {B}^{2} = {( {G}_{1} sin φ - {Y}_{1} cos φ )}^{2} + {( {G}_{1} cos φ + {Y}_{1} sin φ )}^{2} = {G}_{1}^{2} + {Y}_{1}^{2} \\ and so : \qquad ( 25 )$$

$$B = ( {G}_{1} cos φ + {Y}_{1} sin φ ) = \sqrt{{G}_{1}^{2} + {Y}_{1}^{2} - {A}^{2}} = \sqrt{{G}_{1}^{2} + {Y}_{1}^{2} - {{χ}^{2} ( {Y}_{1} + {Y}_{2} - Yc )}^{2}} \qquad ( 26 )$$

Substitution of Equation (9) to Equation (6) gives us:

$${χ}^{2} ( {G}_{1} + {G}_{2} ) - χ \sqrt{{G}_{1}^{2} + {Y}_{1}^{2} - {{χ}^{2} ( {Y}_{1} + {Y}_{2} - Yc )}^{2}} - {G}_{P} = 0 \qquad ( 27 )$$

On rearrangement:

$${( {χ}^{2} ( {G}_{1} + {G}_{2} ) - {G}_{P} )}^{2} = {χ}^{2} ( {G}_{1}^{2} + {Y}_{1}^{2} - {{χ}^{2} ( {Y}_{1} + {Y}_{2} - Yc )}^{2} ) \qquad ( 28 )$$

On simplification:

$${( {χ}^{2} )}^{2} ( {( {G}_{1} + {G}_{2} )}^{2} + {( {Y}_{1} + {Y}_{2} - Yc )}^{2} ) - 2 {χ}^{2} ( ( {G}_{1} + {G}_{2} ) {G}_{P} - 0.5 ( {G}_{1}^{2} + {Y}_{1}^{2} ) ) + {G}_{P}^{2} = 0 \qquad ( 29 )$$

The bi-quadratic equation of χ² has only one appropriate analytical solution:

$${χ}^{2} = \frac{\begin{matrix}( {G}_{1} + {G}_{2} ) {G}_{P} - 0.5 ( {G}_{1}^{2} + {Y}_{1}^{2} ) + \\ \sqrt{\begin{matrix}( ( {G}_{1} + {G}_{2} ) {G}_{P} - 0.5 ( {G}_{1}^{2} + {Y}_{1}^{2} ) {{G}_{P}^{2} ( {( {G}_{1} + {G}_{2} )}^{2} )}^{2} + \\ {( {Y}_{1} + {Y}_{2} - Yc )}^{2} )\end{matrix}}\end{matrix}}{{( {G}_{1} + {G}_{2} )}^{2} + {( {Y}_{1} + {Y}_{2} - Yc )}^{2}} \qquad ( 30$$

equation (30) can be overwritten as:

$${λ}_{r} \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} = 1 + \sqrt{1 - \frac{{G}_{P}^{2} [ {( {G}_{1} + {G}_{2} )}^{2} + {( {Y}_{1} + {Y}_{2} - {Y}_{C} )}^{2} ]}{{[ ( {G}_{1} + {G}_{2} ) {G}_{P} + 0.5 ( {G}_{1}^{2} + {Y}_{1}^{2} ) ]}^{2}}} , \\ \text{Or:} \qquad ( 31 )$$

$${λ}_{r} ρ = 1 + \sqrt{1 - α ρ} , \\ \text{Where:} \qquad ( 32 )$$

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} , \qquad ( 33 )$$

$$α = \frac{{G}_{P}^{2}}{[ ( {G}_{1} + {G}_{2} ) {G}_{P} + 0.5 ( {G}_{1}^{2} + {Y}_{1}^{2} ) ]} , \qquad ( 34 )$$

the following simplifications can be performed by changing and substitution of variables, defining the following:
the equation (32) has only one appropriate solution:

$$ρ = \frac{2 {λ}_{r} - α}{{λ}_{r}^{2}} , \qquad ( 35 )$$

returning to (34) the requiring capacitive admittance (Y_{C}) (reciprocal to capacitive reactance X_{C}) able to change output voltage up (determined by λᵣ) can be estimated as:

$${Y}_{C} = {Y}_{1} + {Y}_{2} - \sqrt{ρ \frac{( {G}_{1} + {G}_{2} ) {G}_{P} + 0.5 ( {G}_{1}^{2} + {Y}_{1}^{2} )}{{( {G}_{1} + {G}_{2} )}^{2}}} \qquad ( 36 )$$

from (36) the capacitance value C is following:

$$C = \frac{{Y}_{C}}{ω} \qquad ( 37 )$$

According to some embodiments, it can be easily shown (by the analysis of a derivative of λᵣ vs Y_{C} in (32)) that the amplification effect of the output voltage is limited by the following magnitude of Y_{C} equal to:

$${( {Y}_{C} )}_{vmax} = {Y}_{1} + {Y}_{2} \to {C}_{vmax} = \frac{{Y}_{1} + {Y}_{2}}{ω} . \qquad ( 38 )$$

Meaning that Cᵥₘₐₓ is the value of capacitance that brings to the maximal voltage increase, when connected in parallel to the load,

and ultimate voltage increase is:

$${χ}_{m ax} = \sqrt{\frac{\begin{matrix}( {G}_{1} + {G}_{2} ) {G}_{P} + 0.5 ( {G}_{1}^{2} + {Y}_{1}^{2} ) + \\ \sqrt{{[ ( {G}_{1} + {G}_{2} ) {G}_{P} + 0.5 ( {G}_{1}^{2} + {Y}_{1}^{2} ) ]}^{2} - {{G}_{P}^{2} ( {G}_{1} + {G}_{2} )}^{2}}\end{matrix}}{{( {G}_{1} + {G}_{2} )}^{2}}} . \qquad ( 39 )$$

depending on the parameters of the distribution line, of a consumer and supplementary generation capability the amplification effect can easily achieve up to 200-300% of a nominal value.

FIG. 4 schematically shows relative voltage changes vs capacitance of the load, when the capacitor/s are connected with the load, according to some embodiments. It can be seen that the peak point is a capacitance

$${C}_{vmax} = \frac{{Y}_{1} + {Y}_{2}}{ω}$$

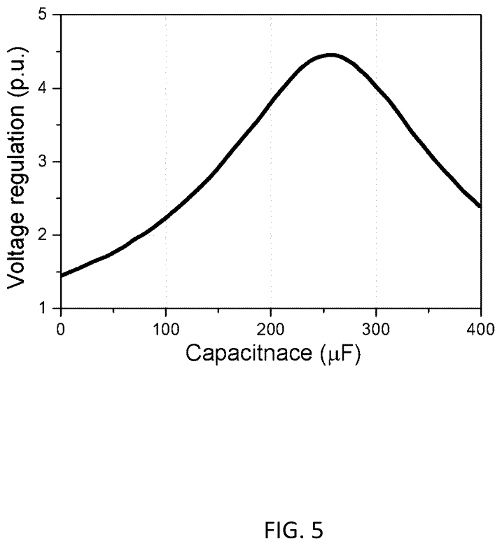

for which the change (increase) in the voltage is maximal. The relative voltage regulation in FIG. 5 was obtained as a square root of Eq. (30), for the following parameters of a distribution line: R1=40Ω, X1=13.3Ω, R2=104Ω, X2=520Ω and for grid 50 Hz.

According to some embodiments, when there is a need to reduce the output voltage, the necessary reactance (X_{coil}) is applied based on (33):

$${Y}_{coil} = \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} - \frac{1}{{X}_{2}} , \qquad ( 40 )$$

$${L}_{coil} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} \frac{1}{{X}_{2}} ]} , \qquad ( 41 )$$

it is important to note that the coefficient ρ in equation (36) has a magnitude greater than one, while in equations (40, 41) it is less than one.

According to some embodiments, the electrical network 106 may further include one or more additional power sources connected to the electrical network 106 for providing a supplementary electrical power P where

$${G}_{P} = \frac{P}{{V}_{S}^{2}} ,$$

wherein P is sampled every m seconds, thereby allowing calculating the resistance R2 and the reactance X2 of the load.

According to some embodiments, controller 105 is further configured to correct the voltage, by:
defining a parameter ρ, wherein

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} ,$$

ρ>1;
determine parameter ρ according to the required voltage correction;
defining α parameter α wherein

$$α = \frac{{G}_{P}^{2}}{[ ( {G}_{1} + {G}_{2} ) {G}_{P} + 0.5 ( {G}_{1}^{2} + {Y}_{1}^{2} ) ]} ;$$

and
calculating α according to the determined ρ parameter.

According to some embodiments system 100 further includes a voltage control appliance to facilitate the correction of the voltage gradually over a specified number of AC periods up to a moment the voltage returns at its nominal value. As explained, the volage control functionality such as a tap changer are slow and correct the voltage during several AC periods. In this case according to some embodiments, controller 105 is configured estimate the required C (or Lcoil) and connecting the required number n of capacitors in parallel to the load and upon correcting the voltage by the voltage control functionality, estimating again the required C (according to the equation (38)) and decreasing the capacitance accordingly, by disconnecting one or more capacitors from the n capacitors. According to some embodiments controller 105 is configured to repeatedly estimate C as the voltage control functionality corrects the voltage and repeatedly decrease the capacitance accordingly, by disconnecting one or more capacitors from the n capacitors, until the required capacitance is C=0 and all n capacitors are disconnected. According to some embodiments, the capacitors are connected and/or disconnected with switches.

According to some embodiments, controller 105 is further configured to correct voltage by estimating a required inductance to be connected in parallel to the load, according to

$${L}_{coil} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} \frac{1}{{X}_{2}} ]} , \qquad ( 41 )$$

wherein one or more additional power sources are connected to the electrical network 106 for providing a supplementary electrical power P and wherein

$${G}_{P} = \frac{P}{{V}_{S}^{2}}$$

and wherein

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$

and ρ<1;

According to some embodiments, controller 105 is configured to connect n inductors in parallel to the load to provide the required inductance Lcoil.

According to some embodiments, system 100 may further comprising a voltage control functionality integrated into the electrical network 106 to facilitate gradual voltage correction over a specified number of AC periods up to a moment the voltage returns at its nominal value. Controller 105 is then configured to correct voltage by estimating a required Lcoil value and increasing the inductance accordingly, by disconnecting one or more inductors from the n inductors. Upon correcting the voltage by the voltage control functionality, controller 105 is configured to estimate the required Lcoil and decreasing the inductance accordingly, by disconnecting one or more inductors from the n inductors. According to some embodiments, controller 105 is configured to repeatedly estimating Lcoil as the voltage control functionality corrects the voltage and repeatedly decreasing the inductance accordingly, by disconnecting one or more inductors from the n inductors, until the required inductance is L_{coil}=0 and all n inductors are disconnected.

According to some embodiments, a method for fast voltage correction during less than a half of an AC period in an electrical network 106 connected to an AC voltage source and a load is presented herein. According to some embodiments, the method includes first, sampling and/or measuring N points of voltage of the AC voltage signal Vᵢ, where i=1, 2 . . . N, during less than a half of the AC period, where each point is measured/sampled at a time tᵢ. Then, the method includes estimating the RMS voltage during less than a half of an AC period. According to some embodiments, a first option for estimating the RMS voltage during less than a half of an AC period, includes calculating/estimating a correction coefficient Kc and then, estimating the RMS voltage taking into account the correction coefficient Kc. According to some embodiments, a second option for estimating the RMS voltage during less than a half of an AC period, includes fitting the measured points by representation as a sum of first k-odd sinusoidal harmonics, by applying approximation of the measured points using Least-Mean-Square approach (LMS). According to some embodiments, a third option for estimating the RMS voltage during less than a half of an AC period, includes storing the Vi values of the N sampled pointes representing each half of the entire AC period in a stack with the same N places, and estimating the RMS voltage of the N points. Then, repeatedly sampling and acquiring new voltage points and storing each newly acquired voltage point in the stack, such that the first oldest stored voltage point in the stack is removed such that the total number of measured points in the stack remains constant and equal to N. For each new sampled point, estimating the RMS voltage value with the new sampled voltage point. Advantageously, each one of the three options for fast estimation of the RMS voltage during less than a half of an AC period is highly accurate in addition to being fast, therefore application which require high accuracy degree may use the presented options. In addition, the high accuracy leads to more efficient correction of the voltage and eliminates damage to electrical equipment in the electrical network 106 and consumers.

According to some embodiments, after estimating the RMS voltage during less than a half of an AC period, the method includes comparing the estimated value of RMS voltage to a predetermined range of values of voltage required/allowed (i.e., nominal value/s), to assess the needed correction of voltage. Eventually, according to some embodiments, the method includes correcting voltage before a next half of the AC period by calculating a required value of reactive power needed to be connected to the electrical network 106 to increase and/or decrease voltage in order to be in the required range of nominal values and attaching/connecting one or more reactive components with the required value of reactive power in parallel to the load before the beginning of the next half of the AC period, thereby correcting the voltage during less than a half of the AC period.

According to some embodiments the AC voltage source provides a voltage signal with a frequency f. According to some embodiments f is 50 Hz. According to some other embodiments f may be 60 Hz, 200 Hz or 400 Hz, each is a separate embodiment. According to some embodiments, f may be any frequency.

According to some embodiments, the electrical network 106 includes distribution lines, transmission line, electrical substation and the like.

According to some embodiments, the N points are equidistantly dispersed points of voltage Vi magnitudes during less than a half of the AC period. According to some embodiments, N≥100 points.

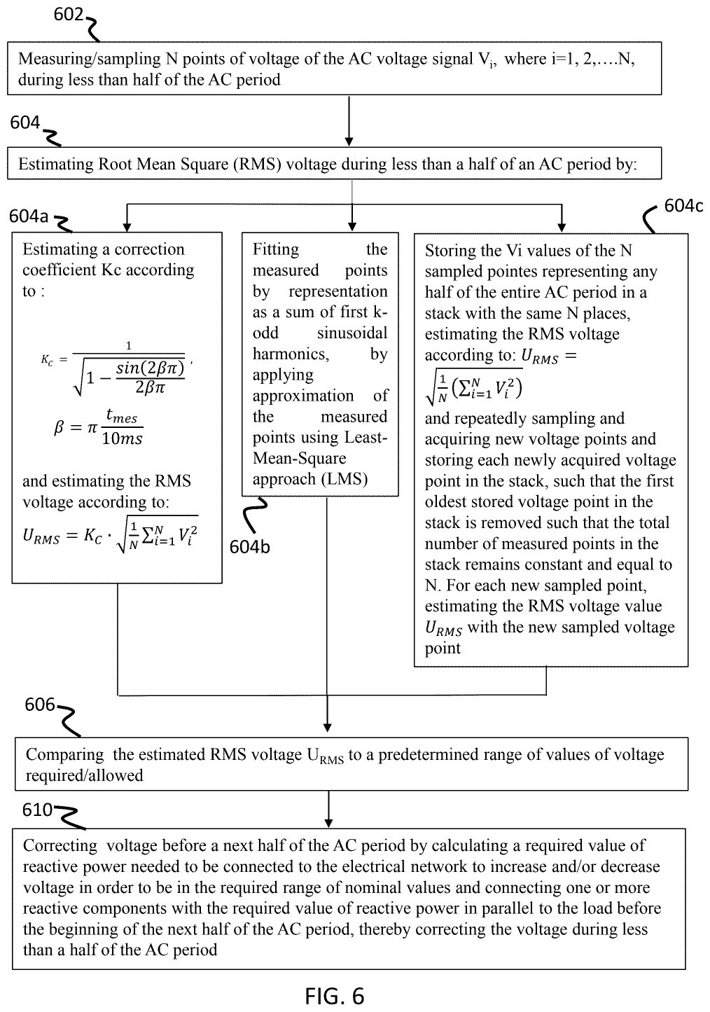

Reference is now made to FIG. 6, which schematically shows a flow-chart of a method for fast correction of voltage during less than a half of an AC period, in an electrical network 106 connected to an AC voltage providing a voltage signal, according to some embodiments. According to some embodiments, at step 602, N points of voltage the of AC voltage signal Vᵢ are sampled/measured during less than half of the AC period, where i=1, 2, . . . N. each point is measured/sampled at a time tᵢ. According to some embodiments at step 604, the RMS voltage is estimated during less than a half of an AC period. According to some embodiments, step 604 of the fast RMS estimation during less than a half of an AC period may be applied in three different ways. In the first option 604a, a correction coefficient Kc is calculated/estimated according to the formula:

$${K}_{C} = \frac{1}{\sqrt{1 - \frac{sin ( 2 β π )}{2 β π}}} , \\ β = ω {t}_{m es} , \qquad ( equations 2 and 3 )$$

wherein β is a dimensionless coefficient, which is dependent on the total time measurement tₘₙₑₛ during which the N points are measured (tₘₑₛ=t_{(i=N)}−t₁). Then, the RMS voltage U_{RMS} is estimated taking the correction coefficient into consideration, according to:

$${U}_{R M S} = {K}_{C} \cdot \sqrt{\frac{1}{N} {\sum }_{i = 1}^{N} {V}_{i}^{2}} . \qquad ( 4 )$$

The full development of the correction coefficient is presented above.

According to some embodiments, in a second option 604b, the N measured points are fitted by representation as a sum of first k-odd sinusoidal harmonics, by applying approximation of the measured points using Least-Mean-Square approach (LMS). According to some embodiments, an approximation criterion is applied according to:

$$S = {\sum }_{i = 1}^{k} {[ {V}_{i} - {A}_{1} sin ( ω {t}_{i} ) - {A}_{3} sin ( 3 ω {t}_{i} ) - … - {A}_{2 k - 1} sin ( ( 2 k - 1 ) ω {t}_{i} ) ]}^{2} \to MIN \qquad ( 11 )$$

where S is an approximation criterion, A₁, A₃ . . . A₂ₖ₋₁ are amplitudes of the 2k−1-odd sinusoidal harmonics of the AC signal, ω is a base angular frequency of the voltage signal, and wherein A₁, A₃ . . . A₂ₖ₋₁ are found to fulfill the mentioned above sum S to its minimal value. To get a minimum of the criterion S all partial derivatives dS/dAi are equalized to zero:

$$( \begin{matrix}\begin{matrix}\begin{matrix}\frac{\partial S}{\partial {A}_{1}} = {\sum }_{i = 1}^{k} sin ( ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ;\end{matrix} \\ ⋯\end{matrix} \\ \begin{matrix}\begin{matrix}\frac{\partial S}{\partial {A}_{n}} = {\sum }_{i = 1}^{k} sin ( ( 2 n - 1 ) ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ;\end{matrix} \\ ⋯\end{matrix} \\ \begin{matrix}\frac{\partial S}{\partial {A}_{k}} = {\sum }_{i = 1}^{k} sin ( ( 2 k - 1 ) ω {t}_{i} ) [ {V}_{i} - {A}_{1} sin ( ω {t}_{i} ) - … - \\ {A}_{2 k - 1} sin ( ( 2 k - 1 ) ω {t}_{i} ) ] = 0 ;\end{matrix}\end{matrix} ) \qquad ( 13 )$$

This set of equations represents a system of k-linear algebraic equations. Sₘᵢₙ can be found by solving the system of K-linear algebraic equations which is represented in a matrix form as follows:

$$( \begin{matrix}{A}_{1} \\ {A}_{3} \\ ⋮ \\ {A}_{2 k - 1}\end{matrix} ) = {( \begin{matrix}{a}_{11} & {a}_{12} & ⋯ & {a}_{1 k} \\ {a}_{21} & {a}_{22} & ⋯ & {a}_{2 k} \\ ⋯ & … & ⋯ & ⋯ \\ {a}_{k 1} & {a}_{k 2} & ⋯ & {a}_{kk}\end{matrix} )}^{- 1} \cdot ( \begin{matrix}{U}_{1} \\ {U}_{2} \\ ⋮ \\ {U}_{k}\end{matrix} ) \\ where : \qquad ( 14 )$$

$${U}_{i} = {\sum }_{i = 1}^{N} {V}_{i} sin ( ( 2 n - 1 ) \cdot ω {t}_{i} ) , n ∈ 1 , … , k \qquad ( 15 )$$

$${a}_{l m} = {\sum }_{i = 1}^{N} sin ( ( 2 l - 1 ) \cdot ω {t}_{i} ) \cdot sin ( ( 2 m - 1 ) \cdot ω {t}_{i} ) , l , n ∈ 1 , … , k \qquad ( 16 )$$

According to some embodiments, in a third option 604c, the Vi values of the N sampled pointes, are stored in a stack with the same N places. According to some embodiments, the N sampled points represent any half of period out of the entire AC period, that is the half of the AC period may be of any AC period for example the first half of the first AC period, the second half of the first AC period, the first half of the second AC period, the second half of the second AC period and the like, or in other words the N sampled points represent any half of the entire AC period, i.e., T/2x where, x=1, 2, 3 . . . , and T is the AC period. According to some embodiments, the RMS voltage is then estimated according to:

$${U}_{R M S} = \sqrt{\frac{1}{N} ( {\sum }_{i = 1}^{N} {V}_{i}^{2} )} . \qquad ( 17 )$$

According to some embodiments, new voltage points are sampled and acquired and each newly acquired voltage point is stored in the stack. According to some embodiments, the stack storage is managed such that for each newly stored voltage point, the oldest of stored voltage point in the stack is removed such that the total number of measured points in the stack remains constant and equal to N. And for each new sampled point, the RMS voltage value is estimated with the new sample, according to (17)

$${U}_{R M S} = \sqrt{\frac{1}{N} ( {\sum }_{i = 1}^{N} {V}_{i}^{2} )} .$$

According to some embodiments, at step 606 the estimated RMS voltage U_{RMS} is compared to a predetermined range of values of voltage required/allowed (nominal value/s). According to some embodiments, at step 610 the voltage in the electrical network 106 is corrected before a next half of the AC period by calculating a required value of reactive power needed to be connected to the network 106 to increase and/or decrease voltage in order to be in the required range of nominal values. According to some embodiments, a one or more reactive components with the required value of reactive power are connected to the electrical network 106 before the beginning of the next half of the AC period, thereby correcting the voltage during less than a half of the AC period.

According to some embodiments, the electrical network 106 includes or is connected to a transmission line and/or distribution line, where a resistance r1 and a reactance x1 of the distribution line are connected in serial and a resistance r2 and a reactance x2 of the load are connected in serial.

According to some embodiments, the electrical network 106 includes or is connected to a transmission and/or a distribution line and is represented by an equivalent circuit which is connected to a voltage source providing a voltage signal Vs, and where a resistance R1 and a reactance X1 of the distribution line are connected in parallel and a resistance R2 and a reactance X2 of the load are connected in parallel, wherein as in equation (18):

$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} . \qquad ( 18 )$$

A voltage magnification coefficient is defined as

$$λ r = {( \frac{Vo}{Vs} )}^{2} and χ = \frac{{V}_{o}}{{V}_{s}} ,$$

where Vo is an output voltage.

According to some embodiments, step 610 of correcting voltage, includes the step of estimating a required capacitance to be connected in parallel to the load, according to:

$$C = \frac{Yc}{ω} \qquad ( 37 )$$

wherein

$$Yc = \frac{1}{Xc}$$

and Xc is the reactance of the capacitance required to be connected, and ω is the base angular frequency of the voltage signal.

According to some embodiments, a required capacitance, which brings to a maximal voltage increase, to be connected in parallel to the load, is estimated according to:

$${C}_{vmax} = \frac{{Y}_{1} + {Y}_{2}}{ω} . \qquad ( 38 )$$

Thereby providing information regarding the maximal voltage increase allowed.

According to some embodiments, step 610 of correcting voltage, further includes the step of connecting n capacitors in parallel to the load to provide the required capacitance C.

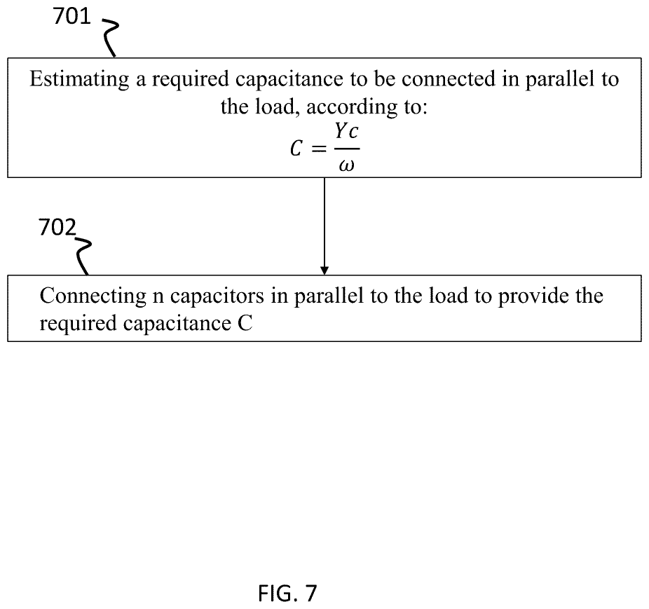

FIG. 7 schematically shows a flowchart of a method for correcting voltage by estimating a required capacitance C and connecting the same in parallel to the load, according to some embodiments. At step 701 a required capacitance C for correcting voltage is estimated according to equation (37)

$$C = \frac{Yc}{ω} .$$

At step 702, according to some embodiments, n capacitors providing the required estimated value C are connected in parallel to the load, thereby correcting the voltage during less than a half of an AC period.
According to some embodiments, one or more additional power sources may be connected to the electrical network 106 for providing a supplementary electrical power P where

$${G}_{P} = \frac{P}{{V}_{S}^{2}} ,$$

and wherein P is sampled every m seconds, thereby allowing calculating the resistance R2 and the reactance X2 of the load.

According to some embodiments, for correcting the voltage in the electrical network 106 and estimating C, a parameter ρ is defined as

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} ,$$

and ρ>1. According to some embodiments, parameter ρ is determined according to the required voltage correction. Another parameter is also defined as

$$α = \frac{{G}_{P}^{2}}{[ ( {G}_{1} + {G}_{2} ) {G}_{P} + 0.5 ( {G}_{1}^{2} + {Y}_{1}^{2} ) ]} .$$

According to some embodiments, α is calculated according to the determined ρ parameter.

According to some embodiments, the additional power sources may be a Photo Voltaic (PV) stations, wind turbines, generators and the like.

According to some embodiments, for engineering applications, it is important to calculate the magnitude of the source current (I_{S}). It is calculated as a solution to the following equation:

$${\dot{I}}_{S} = \frac{χ {V}_{S}}{{R}_{2}} - j \frac{χ {V}_{S}}{{X}_{2}} + j \frac{χ {V}_{S}}{{X}_{c}} - \frac{P}{χ {V}_{S}} \qquad ( 42 )$$

For simplicity, it is considered that the V has real part only. After rearrangement and reduction to a dimensionless form, Eq. (17) transforms as:

$${\dot{I}}_{S} = \frac{χ {V}_{S}}{{R}_{2}} - \frac{P}{χ {V}_{S}} - {jV}_{S} ( \frac{χ}{{X}_{2}} - \frac{χ}{Xc} ) \qquad ( 43 )$$

The solution of the I_{S}:

$${I}_{S} = \sqrt{{( \frac{χ {V}_{S}}{{R}_{2}} - \frac{P}{χ {V}_{S}} )}^{2} + {{V}_{S}^{2} ( \frac{χ}{{X}_{2}} - \frac{χ}{Xc} )}^{2}} \qquad ( 44 )$$

where Vs is the voltage of the AC voltage source, R₂ is the resistance of the load, P is the power of the supplementary power facility, V₀ is the output voltage,

$$χ = \frac{Vo}{Vs}$$

and Xc is the reactance of a capacitance C connected to the load in parallel.

In a more convenient dimensionless form, it is received:

$$\frac{{I}_{s}}{{I}_{b}} = \sqrt{{( χ - \frac{{PR}_{2}}{χ {V}_{S}^{2}} )}^{2} + {( \frac{χ {R}_{2}}{{X}_{2}} - χω {CR}_{2} )}^{2}} \qquad ( 45 )$$

where I_{b} is the current in the distribution line at C=0.

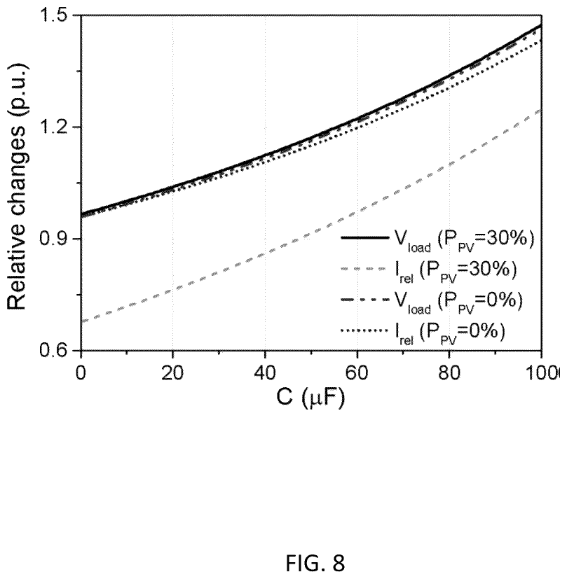

FIG. 8 schematically shows relative enhancement of load voltage and source current as a function of capacitance increases for PV power of 0% and 30%, according to some embodiments. It is noted that the voltage enhancement is accompanied by the increase of source current, which is the inevitable compliment for voltage improvement.

According to some embodiments, a voltage control functionality such as a tap changer is integrated into the electrical network 106 to facilitate gradual voltage correction over a specified number of AC periods up to a moment the voltage returns at its nominal value. In that case correcting voltage further includes the steps of upon correcting the voltage by the voltage control functionality, estimating required C and decreasing the capacitance accordingly, by disconnecting one or more capacitors from the n capacitors. Then, repeatedly estimating C as the voltage control functionality corrects the voltage and repeatedly decreasing the capacitance accordingly, by disconnecting one or more capacitors from the n capacitors, until the required capacitance is C=0 and all n capacitors are disconnected.

According to some embodiments, the capacitors are connected to the load for about 40-150 seconds and then, the capacitors are disconnected, thereby allowing the voltage control functionality to fully correct the voltage such that no capacitance is required to be connected to the load.

According to some embodiments, the capacitors are connected at the beginning or end of a voltage AC period. According to some embodiments, the capacitors are connected and/or disconnected with switches.

According to some embodiments, when correcting the voltage, one or more capacitors may be connected to the load for increasing the voltage. According to some embodiments, one or more inductors may be connected to the load for decreasing the voltage.

According to some embodiments, step 610 of correcting voltage, may also include the step of estimating a required inductance to be connected in parallel to the load. The inductance is estimated according to:

$${L}_{c o i l} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} - \frac{1}{{X}_{2}} ]} , \qquad ( 41 )$$

wherein one or more additional power sources are connected to the electrical network 106 for providing a supplementary electrical power P and wherein

$${G}_{P} = \frac{P}{{V}_{S}^{2}} .$$

In this case parameter ρ is defined as

$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$

and ρ<1.

In this case, n inductors are connected in parallel to the load to provide the required inductance Lcoil.

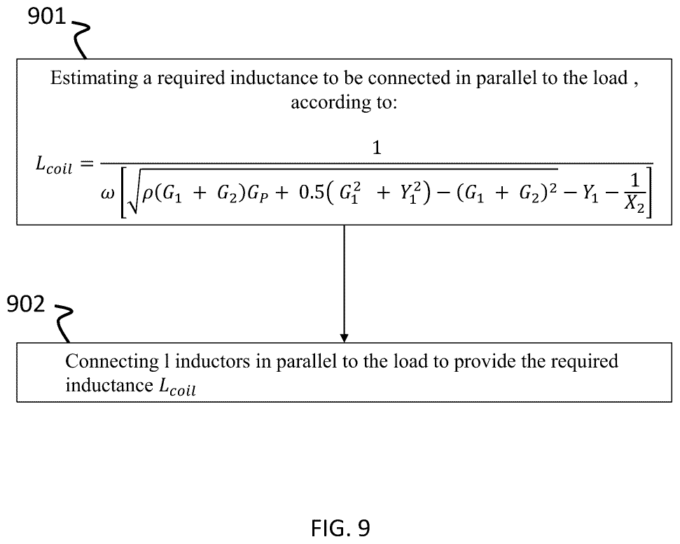

FIG. 9 schematically shows a flowchart of a method for correcting voltage by estimating a required inductance Lcoil and connecting the same in parallel to the load, according to some embodiments. At step 901 a required inductance Lcoil for correcting voltage is estimated according to equation (41):

$${L}_{c o i l} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} - \frac{1}{{X}_{2}} ]} .$$

At step 902, according to some embodiments, 1 inductors providing the required estimated value Lcoil are connected in parallel to the load, thereby correcting the voltage during less than a half of an AC period.

According to some embodiments, when 1 inductors are connected to the load to correct the voltage, and a voltage control functionality is integrated into the electrical network 106, the following steps are applied: upon correcting the voltage by the voltage control functionality, a required Lcoil is estimated, and the inductance decreases (as the voltage control functionality started to correct the voltage), therefore, one or more inductors from the n inductors connected to the load are disconnected. According to some embodiments, Lcoil is repeatedly estimated as the voltage control functionality corrects the voltage and so repeatedly decreasing the inductance accordingly, by disconnecting one or more inductors from the n inductors, until the required inductance is Lcoil=0 and all n inductors are disconnected.

According to some embodiments, the inductors are connected to the load for about 40-150 seconds, thereby allowing the voltage control functionality to fully correct the voltage such that no inductance is required to be connected to the load.

According to some embodiments, the inductors are connected at the beginning or end of a voltage AC period. According to some embodiments, the inductors are connected and/or disconnected with switches.

According to some embodiments,

### EXAMPLES

### Example 1: Comparing the Accuracy of the Rms Voltage Estimation Options During Less than a Half of an Ac Period

In this example an experiment was carried out to compare the accuracy of three different methods/options for estimating RMS voltage during less than a half of an AC period. The first method is a known method of estimating the RMS voltage during less than a half of an AC period by measuring voltage amplitude. The second method is estimating RMS voltage during less than a half of an AC period by estimating a correction coefficient Kc. The third method is estimating RMS voltage during less than a half of an AC period by fitting measured points with trigonometric functions representing voltage harmonics. A set of laboratory measurements was carried out to verify the accuracy of all three methods. For the verification of RMS measurement methods and comparison between the methods, a laboratory system was created according to the system presented in FIG. 3.

According to some embodiments, AC source 301 simulates real voltage signal with a content from the first up to 25th odd harmonic. The magnitude of each harmonic was determined by the special standard (applicable in every country) allowing the maximum level of each harmonic in the network. Table 1 schematically shows the relative magnitudes of harmonics in a signal modeling real voltage signal.

TABLE 1
% Of the full voltage

| U₁ | U₃ | U₅ | U₇ | U₉ | U₁₁ | U₁₃ | U₁₅ | U₁₇ | U₁₉ | U₂₁ | U₂₃ | U₂₅ |
|---|---|---|---|---|---|---|---|---|---|---|---|---|
| 99.4 | 5 | 6 | 5 | 1.5 | 3.5 | 3 | 0.5 | 2 | 1.5 | 0.5 | 1.5 | 1.5 |

The method of estimating the RMS voltage during less than a half of an AC period by measuring voltage amplitude, despite being simple and easily applicable provides the lowest precision of the RMS estimation that is not influenced by the sampling time. This method's error is a result of an instability of a voltage signal as well by a lack in synchronization of the measuring amplitude magnitude. Altogether for existing A/D converters its error value lies between 1.30-1, which is an error of 50%.

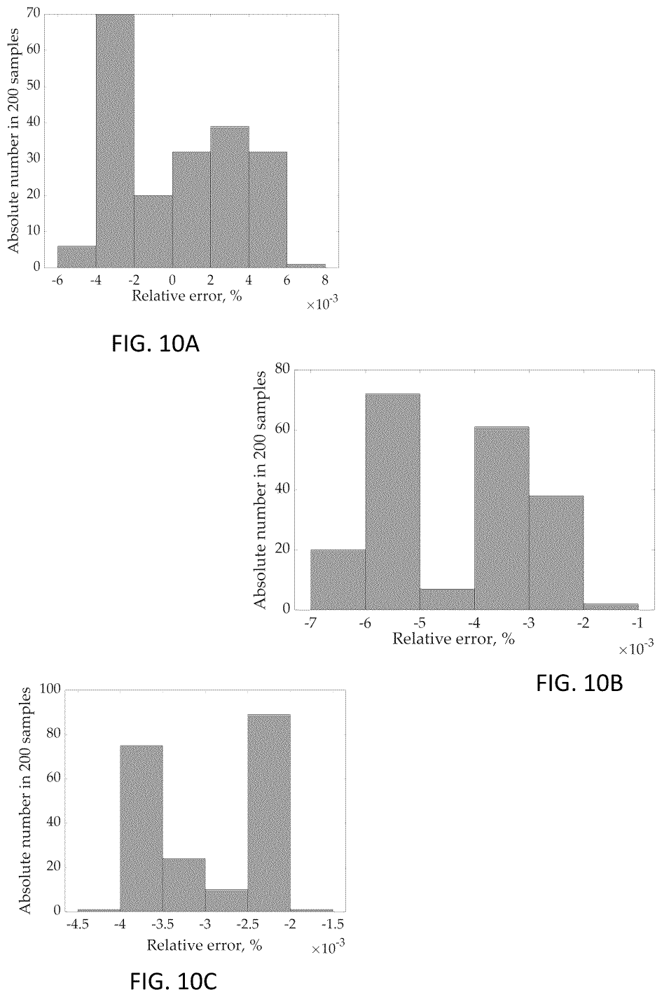

According to some embodiments, the method of estimating a correction coefficient Kc, where the voltage magnitude is sampled and the correction coefficient Kc is taken into account, provides much more precision for RMS estimation. However, this depends on the sampling time. FIG. 10A schematically shows a relative error histogram for sampling time of 5 ms, according to some embodiments. FIG. 10B schematically shows a relative error histogram for sampling time of 7 ms, according to some embodiments, and FIG. 10C schematically shows a relative error histogram for sampling time of 9 ms, according to some embodiments.

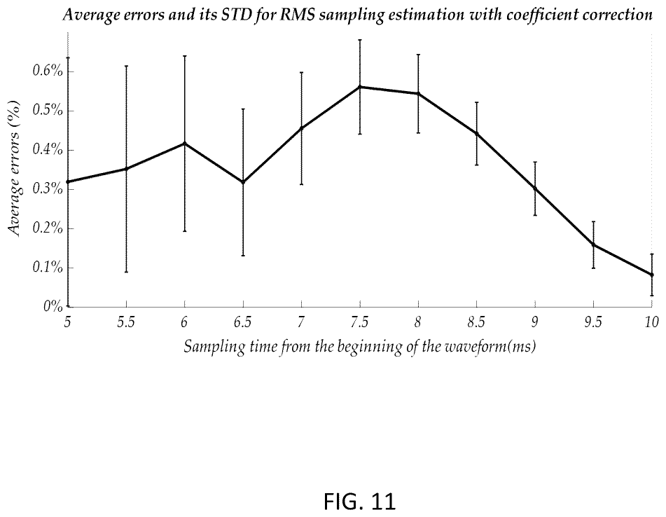

According to some embodiments, Root Mean Square (RMS) Error with its standard deviation (STD) for the method of estimating RMS voltage with a correction coefficient Kc is represented in FIG. 11. The Estimation error of this method is based on a sampling instantaneous voltage magnitude. It can be seen from FIG. 11 that the error and its STD tend to decrease with the sampling time. The error for the suitable sampling time in this example (6-7 ms) can be no more than 0.4-0.6%.

According to some embodiments, in the third method of estimating RMS voltage during less than a half of an AC period by fitting measured points with trigonometric functions representing voltage harmonics, the decomposition of a signal to odd harmonics theoretically should ensure the most accurate results of the RMS value. This method despite being accurate requires significant computational effort that increases as the number of harmonics increases. Considering this circumstance, the RMS estimation error should be investigated in detail.

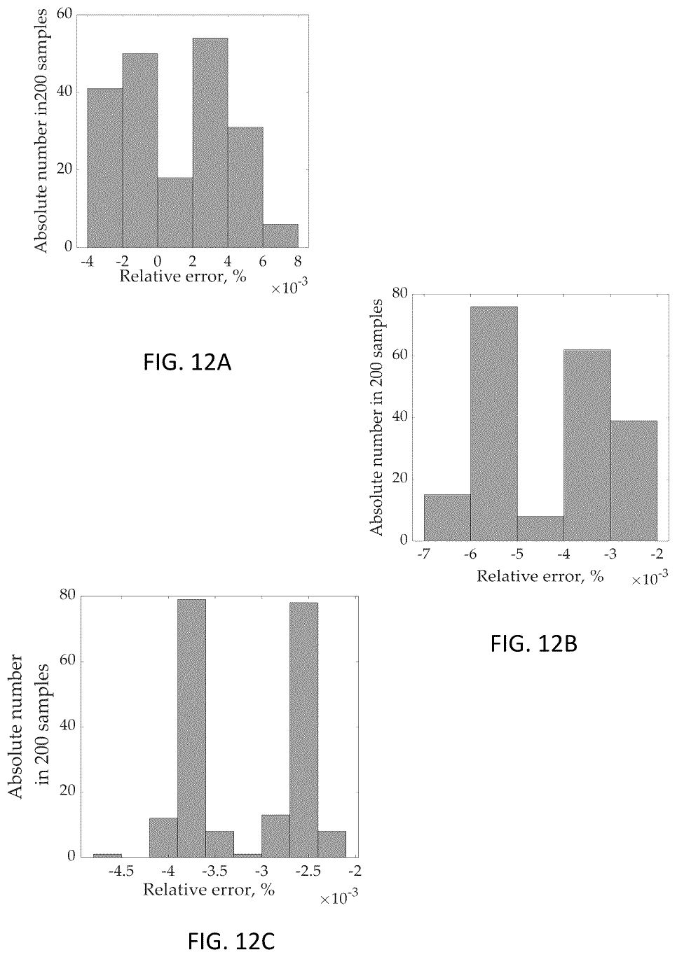

FIG. 12A schematically shows a relative RMS error histogram for one-harmonic estimation with sampling time of 5 ms, according to some embodiments. FIG. 12B schematically shows a relative RMS error histogram for one-harmonic estimation with sampling time of 7 ms, according to some embodiments, and FIG. 12B schematically shows a relative RMS error histogram for one-harmonic estimation with sampling time of 9 ms, according to some embodiments. The same histogram form is for two- and three harmonics signal decomposition.

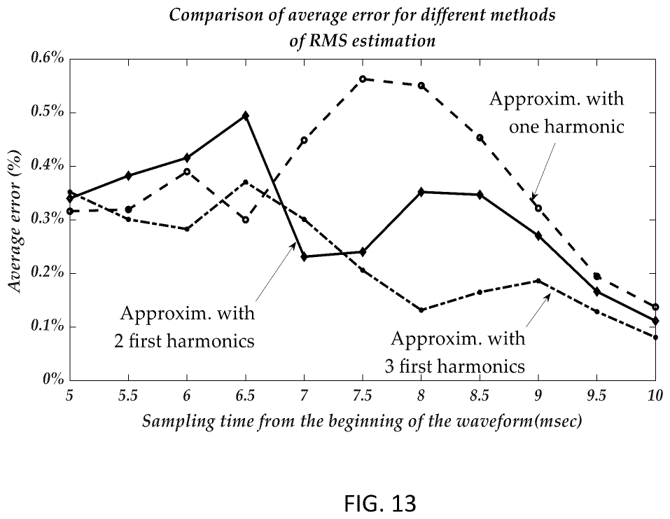

FIG. 13 schematically shows the average relative RMS error for one-two, and three-harmonics representations, according to some embodiments.

According to some embodiments, as in the estimation of a correction coefficient Kc method, the error decreases with the increase of sampling time and with more significant harmonics signal decomposition. The STD of an error can be even more than its average value and is between 0.6-1%. This circumstance can be explained by the relatively low value of an average error having scattered statistics.

According to some embodiments, the accuracy of the method of fitting measured points with trigonometric functions representing voltage harmonics, for a one-harmonics representation is close to that of the estimation with the correction coefficient Kc method based on sampling voltage magnitudes. However, it became significantly more accurate with the use of two- or three harmonics. The average error in this case for the 6-7 ms sampling time is less than 0.25-0.35% substantially better than for the method based on voltage sampling in a fraction of the AC period time.

### Example 2: Verification of the Correction of Voltage by Estimating Required Capacitance and Connecting and Disconnecting Capacitors

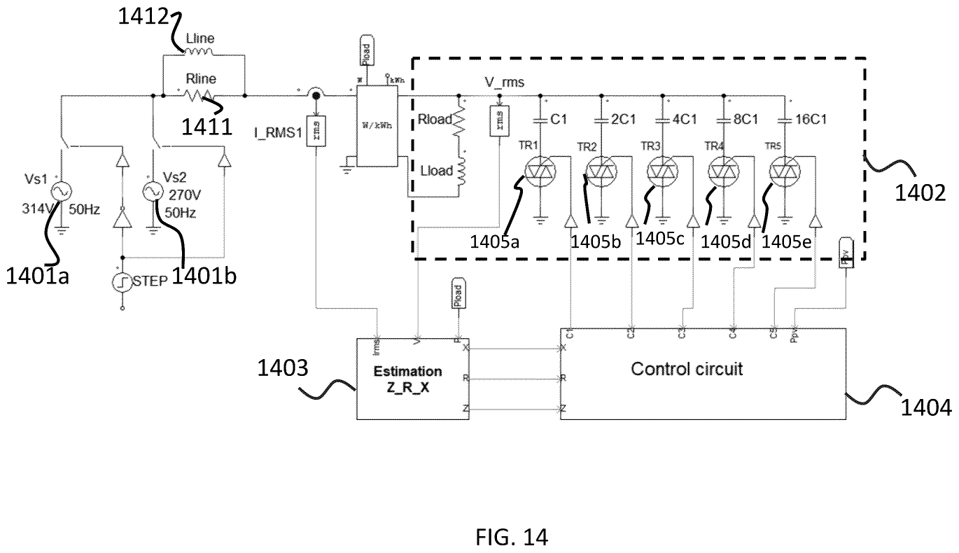

A voltage control system was created to verify the method presented herein. The simulations were carried out using the PSIM software. FIG. 14 schematically shows a simulated circuit of the voltage control system carried out using PSIM software to correct voltage by connecting and disconnecting capacitors, according to some embodiments. The control system includes a chain of Rload-Lload, bank of capacitors 1402, sub-circuit for estimation of load impedance 1403, sub-circuit of control 1404, and capacitors electronic switches (thyristor or TRIAC) 1405a-1405e. In the capacitor bank 1402, the capacitors are arranged in a binary order of capacitances. A distribution line is represented by lumped elements Rline 1411, Lline 1412 connected in parallel. Two AC power sources are connected an AC power source 1401a with nominal voltage, of 340V and an AC power source 1401b with a lower voltage of 240V, both in a frequency of 50 Hz.

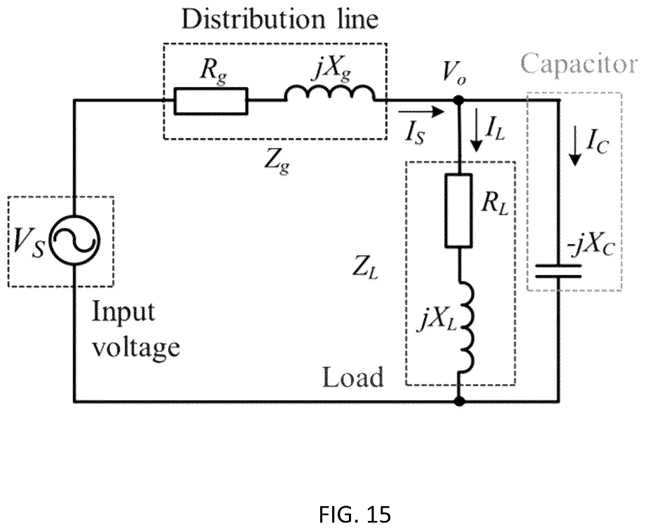

In this experiment the analytical solution of Eq. (30) is verified experimentally. The dynamic process of voltage and current changes during capacitor connection-disconnection to the load is also studied in the experiment.
According to some embodiments, the experimental setup included a voltage source (adjustable regulator transformer, 0-250 V, 1500 VA), six Analog Input Module for the MOSCAD-L RTU, Handheld Power Quality Analyzer, an equivalent consumer impedance, and additional laboratory equipment.
According to some embodiments, a coil was wound on the ferromagnetic core to design the distribution line 1404. The air gap ensures the linearity of the impedance. The equivalent impedance of the modelled distribution line Rline 1411 and Lline 1412 is R_{g}=5.66Ω, X_{g}=15.6Ω. The load was simulated by regulated laboratory inductance, which provides the range of resistance and reactance from 50-200Ω and 5-100 mH. The capacitance bank 1402 has five capacitors with capacitances of 4.4 μF, 9.9 μF, 17.1 μF, 35.4 μF, and 64.8 μF. It is important to note here that the capacitance values are arranged approximately in binary order. All of them have individual switches allowing a total of 32 combinations of different capacitances. Therefore, on/off toggling allows uniform control of reactive power at the end of a line.
FIG. 15 schematically shows an equivalent circuit using for the experiment of correction of voltage by estimating required capacitance and connecting and disconnecting capacitors, according to some embodiments. The parameters of the equivalent circuit are defined as: V_{S} is source voltage, R_{g} is the resistance of the distribution line, X_{g} is the reactance, Z_{g} is the reactance of the distribution line, I_{S} is current in the distribution line, I_{L} is Load current, R_{L} is the resistance of the load, X_{L} is the reactance of load, Z_{L} is reactance X_{C} is the reactance of capacitance, I_{C} is capacitor current, and V₀ is the output voltage.
In the first step, the load voltage alteration and source current increase during capacitive power control were investigated. The load impedance was established to Z_{L}=67.6+j33.0Ω with cosφ=0.9 for definiteness.
After the exclusion of the PV source, Eq. (30) is transformed according to the equivalent circuit:

$${( \frac{{V}_{o}}{{V}_{S}} )}^{2} = \frac{{( \frac{{X}_{C}}{{X}_{L}} )}^{2} [ 1 + {( \frac{{X}_{L}}{{R}_{L}} )}^{2} ]}{{[ \frac{{X}_{C}}{{X}_{L}} ( 1 + \frac{{R}_{g}}{{R}_{L}} ) - \frac{{X}_{g}}{{X}_{L}} - \frac{{R}_{g}}{{R}_{L}} ]}^{2} + {[ \frac{{X}_{C}}{{X}_{L}} ( \frac{{X}_{L}}{{R}_{L}} + \frac{{X}_{g}}{{R}_{L}} ) + \frac{{R}_{g}}{{X}_{L}} - \frac{{X}_{g}}{{X}_{L}} ]}^{2}} \qquad ( 46 )$$

The analytical solution for the current increase versus capacitance value is:

$${( \frac{{I}_{S}}{{I}_{b}} )}^{2} = \frac{[ {( {R}_{g} + {R}_{L} )}^{2} + {( {X}_{g} + {X}_{L} )}^{2} ] [ {R}_{L}^{2} + {( {X}_{L} - {X}_{C} )}^{2} ]}{\begin{matrix}{[ {X}_{C} ( {X}_{L} + {X}_{g} ) + {R}_{g} {R}_{L} - {X}_{g} {X}_{L} ]}^{2} + \\ {[ {X}_{C} ( {R}_{L} - {R}_{g} ) - {X}_{g} {R}_{L} + {R}_{g} {X}_{L} ]}^{2}\end{matrix}} \qquad ( 47 )$$

$$= {( \frac{{R}_{L}}{{X}_{L}} )}^{2} \frac{[ {( \frac{{R}_{g}}{{X}_{L}} + \frac{{R}_{L}}{{X}_{L}} )}^{2} + {( 1 + \frac{{X}_{g}}{{X}_{L}} )}^{2} [ 1 + {( \frac{{X}_{L}}{{R}_{L}} - \frac{{X}_{C}}{{R}_{L}} )}^{2}}{\begin{matrix}{[ \frac{{X}_{C}}{{X}_{L}} ( 1 + \frac{{X}_{g}}{{X}_{L}} ) + \frac{{R}_{g}}{{X}_{L}} \frac{{R}_{L}}{{X}_{L}} - \frac{{X}_{g}}{{X}_{L}} ]}^{2} + \\ {[ \frac{{X}_{C}}{{X}_{L}} ( \frac{{R}_{L}}{{X}_{L}} - \frac{{R}_{g}}{{X}_{L}} ) - \frac{{X}_{g}}{{X}_{L}} \frac{{R}_{L}}{{X}_{L}} + \frac{{R}_{g}}{{X}_{L}} ]}^{2}\end{matrix}} \qquad ( 48 )$$

The current flows in the circuit with zero capacitance connected to the load is termed as a base value current (I_{b}) and expressed as:

$${I}_{b} = {V}_{S} \frac{{R}_{L} + j {X}_{L}}{( {R}_{g} + {R}_{L} ) + j ( {X}_{g} + {X}_{L} )} \qquad ( 49 )$$

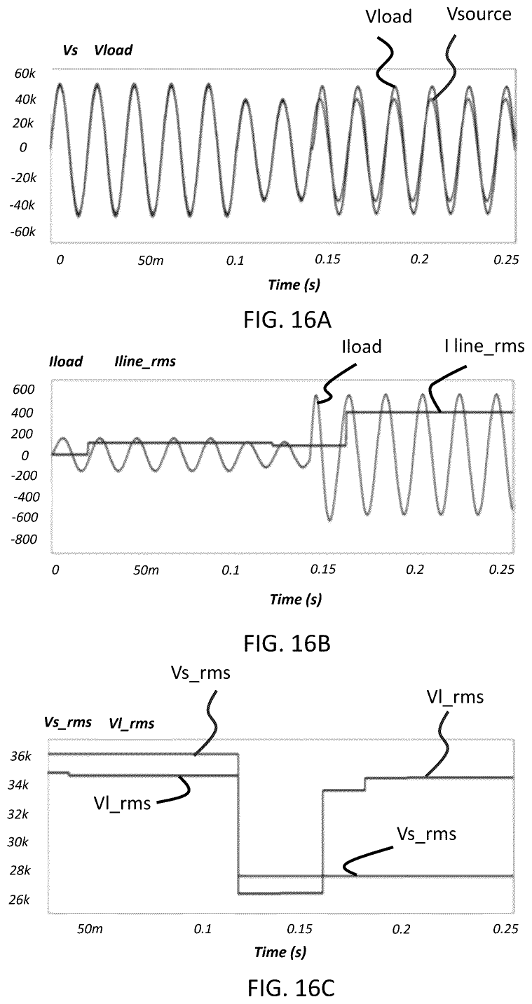

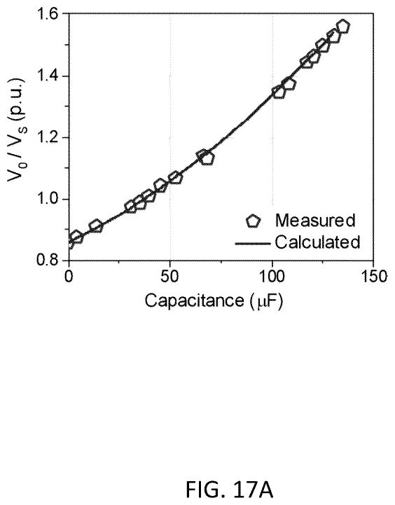

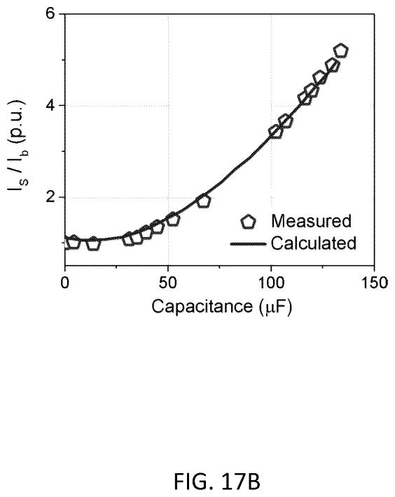

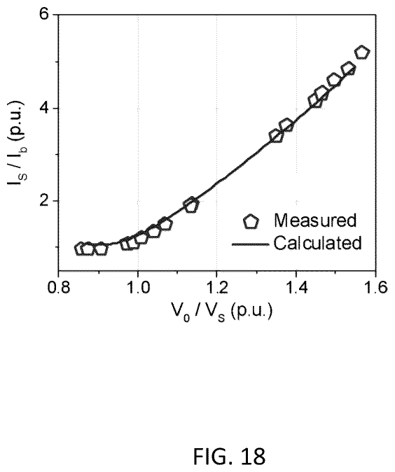

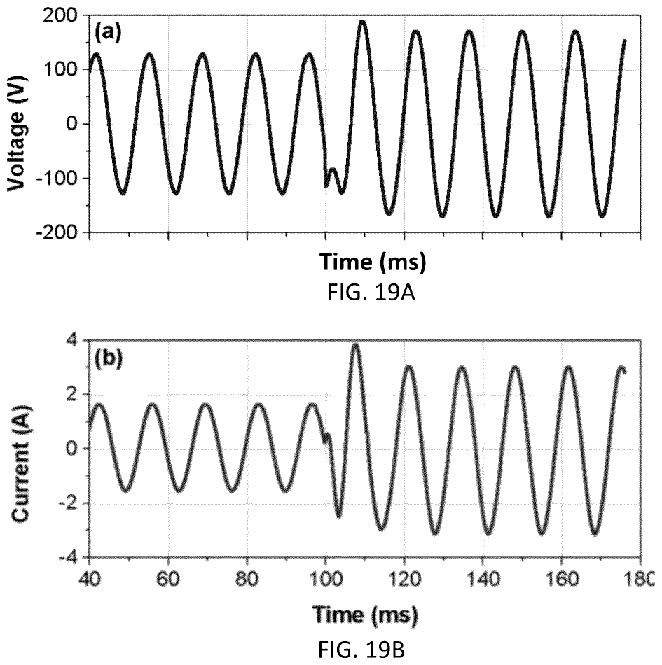

FIGS. 16A-16C schematically presents the output of the control system simulation of the experiment of correction of voltage by estimating required capacitance and connecting and disconnecting capacitors, according to some embodiments. FIG. 16A shows the results for the source voltage behavior and the load voltage behavior. FIG. 16B shows the results for the current in the load and the current in the distribution line. FIG. 16C shows the results for the RMS voltage of the source and the RMS voltage of the load.
The control system to improve voltage instabilities works as follows. The estimation block 1403 calculates the load voltage, current, power, impedance, resistance, and reactance by the permanent measurements. The load voltage is measured during each half- or one-period of AC current. It is carried out by the acquisition of several instantaneous voltage magnitudes during the half- or one-period of AC current. Then the control system approximates these points by a sinusoidal function that amplitude testifies RMS voltage value. This way ensures the fastest reply time needed for the improving voltage level. The load parameters are altered relatively slower rate. Hence, the impedance, resistance, and reactance of load are estimated by the measurements for a prolonged time, approximately several hundreds of periods. All mentioned above s information transfer to the control circuit 1404. Control circuit 1404 compares the total PV power generation (Ppv) and load voltage with the rated value. Now, capacitance magnitude is decided using eq. (28) as per the voltage fluctuations. Further, special capacitors from the bank of capacitors 1402 (C1 . . . C5) are selected, which provide the required capacitance. The control system connects the capacitors to the load and continues this connection until the voltage remains in the allowable limits. If load voltage again changes from the nominal range, the system re-calculates the required capacitance according to present circumstances and connects the required capacitance. According to some embodiments a tap-changer is also connected to the experimental circuit. The tap-changer begins to increase or decrease the transformation ratio after the connection of the required capacitance. Each stage may take approximately 7-10 s depends on the type of tap-changer, and average time of voltage stabilization takes about 100-150 s. In this time, the control system modifies the value of capacitance connected to the load since the voltage is changing when the tap-changer is gradually shifting the transformation ratio. As the voltage achieves the nominal level, the system disconnects capacitors from the load. Therefore, the total duration for one event of voltage instabilities to the nominal one should not exceed ˜30-120 s.
Five capacitors are considered in the binary distribution of capacitance to maintain the efficiency of control system functionality. The accuracy of a capacitance selection is equal to ˜3.1%. Also, it is mentioned that the voltage control can be ˜3% with the bank of 5 capacitors (binary dispersed). More precise results can be obtained with a capacitor bank having more capacitors. The accuracy can be estimated as follows:

$$δ ( \% ) = \frac{1}{{2}^{N}} 100 \% \qquad ( 50 )$$

where N is the total number of binary dispersed capacitors. It is important to note here that the capacitor bank can have many capacitors, but the capacitance distribution should be binary.
FIGS. 17A-17B schematically present theoretical and experimental data of relative voltage and current changes versus capacitance value, according to some embodiments. The experimental results show good agreement with the theoretical analysis. FIG. 17A shows that the relative voltage increases proportionally to capacitance magnitude. As expected, the source current also increases significantly with voltage enhancement as shown in FIG. 17B. These results support the idea that the voltage drop in the distribution line can be improved by applying reactive power at the load.
FIG. 18 schematically present the relative changes in the source current followed by a voltage increase, according to some embodiments. Such information is important for an engineer to develop a voltage stabilization system.
It is stated that the method for voltage correction by connecting capacitance to the load could be applied for a relatively short time. The capacitors should be disconnected as the transformation ratio changes to the needed level using conventional tap-changers. Such abrupt connections-disconnections of capacitance causes a transient process. It is demonstrated that voltage-current curves are exponentially smooth with or without oscillation components during capacitor switching as can be seen in FIGS. 16A-16C. The oscillating transient process is undesirable since it diminishes the quality of electricity. However, the probability of oscillations is negligible for the real impedances of the distribution line and loads. For example, for typical values of R₁=1Ω, R₂=100Ω, L₁=9 mH, L₂=899 mH (cosp of a load equal to 0.94), the voltage/current oscillations appear if capacitance increase more than 5000 μF. The dynamic behavior of voltage and current during capacitor switching was studied experimentally.
FIGS. 19A-19B schematically show voltage and current dynamic response as a function of time, during capacitor switching, according to some embodiments. The curve shown in FIG. 19A represents the measured voltage behavior during capacitor connection and the curve shown in FIG. 19B represents the current behavior during capacitor connection. It is noted that in real time at an electrical network with distribution line there are no disturbances at all and it was observed that the dynamic voltage-current behaviours are appropriate without any undesirable disturbances. The TRIAC switches 1405a-1405e are used to ensure the connection/disconnection of capacitors at the end or beginning of the AC period.
The results of experimental studies confirm the outcome of the analytical analysis. Such a conclusion guarantees a smooth dynamic process for the method of capacitance connection to a load.
Both analytical and experimental data show that source current can enhance substantially during the significant capacitive power application. Therefore, according to some embodiments the capacitive reactive power is applied for a short period (range of 40-120 s). This period is enough for the tap-changers or any other voltage control functionality to correct the transformation ratio. Nevertheless, without a significant current increase, the voltage can be enhanced up to 25-30%. Moreover, the current enhancement can also be diminished by the active power provided by additional power generation facilities (e.g., PV plants).

According to some embodiments, the controller includes a processing unit or module. According to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices. Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus. The processes and displays presented are not inherently related to any particular computer or other apparatus. Various general-purpose systems may be used with programs in accordance with the teachings herein, or it may prove convenient to construct a more specialized apparatus to perform the desired method(s). In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Or processing unit. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

1.-35. (canceled)

36. A method for fast correction of voltage during less than a half of an AC period, in an electrical network connected to an AC voltage source providing a voltage signal with a frequency f, and a load, comprising:
measuring and/or sampling N points of voltage of the AC voltage signal Vᵢ, where i=1, 2, . . . N, during less than half of the AC period, each point is measured/sampled at a time tᵢ;
estimating a Root Mean Square (RMS) voltage during less than a half of an AC period, comprising:
calculating/estimating a correction coefficient Kc according to:
$${K}_{C} = \frac{1}{\sqrt{1 - \frac{sin ( 2 βπ )}{2 β π}}} , β = ω {t}_{m e s}$$
wherein β is a dimensionless coefficient, which is dependent on the total time measurement tₘₑₛ during which the N points are measured;
estimating the RMS voltage U_{RMS}, according to:
$${U}_{R M S} = {K}_{C} \cdot \sqrt{\frac{1}{N} {\sum }_{i = 1}^{N} {V}_{i}^{2}}$$
or
instead of calculating Kc and U_{RMS}, fitting the measured points by representation as a sum of first k-odd sinusoidal harmonics, by applying approximation of the measured points using Least-Mean-Square approach (LMS) according to the formula:
$$S = {\sum }_{i = 1}^{k} {[ {V}_{i} - {A}_{1} sin ( ω {t}_{i} ) - {A}_{3} sin ( 3 ω {t}_{i} ) - … - {A}_{2 k - 1} sin ( ( 2 k - 1 ) ω {t}_{i} ) ]}^{2} \to MIN$$
wherein S is an approximation criterion, A₁, A₃ . . . A₂ₖ₋₁ are amplitudes of the 2k−1-odd sinusoidal harmonics of the AC signal, ω is a base angular frequency of the voltage signal, and
wherein A₁, A₃ . . . A₂ₖ₋₁ are found to fulfill the minimal value of S that is found by solving a system of K-linear algebraic equations which is represented in a matrix form as follows:
$$( \begin{matrix}{A}_{1} \\ {A}_{3} \\ ⋮ \\ {A}_{2 k - 1}\end{matrix} ) = {( \begin{matrix}{a}_{11} & {a}_{12} & … & {a}_{1 k} \\ {a}_{21} & {a}_{22} & … & {a}_{2 k} \\ … & … & … & … \\ {a}_{k 1} & {a}_{k 2} & … & {a}_{kk}\end{matrix} )}^{- 1} \cdot ( \begin{matrix}{U}_{1} \\ {U}_{2} \\ ⋮ \\ {U}_{k}\end{matrix} ) \\ where : \\ {U}_{i} = {\sum }_{i = 1}^{N} {V}_{i} sin ( ( 2 n - 1 ) \cdot ω {t}_{i} ) , n ∈ 1 , … , k \\ {a}_{l m} = {\sum }_{i = 1}^{N} sin ( ( 2 l - 1 ) \cdot ω {t}_{i} ) \cdot sin ( ( 2 m - 1 ) \cdot ω {t}_{i} ) , l , m ∈ 1 , … , k ;$$
or
instead of calculating Kc and
$${U}_{R M S} = {K}_{C} \cdot \sqrt{\frac{1}{N} {\sum }_{i = 1}^{N} {V}_{i}^{2}} ,$$
storing the Vi values of the N sampled points representing any half of the entire AC period in a stack with the same N places;
estimating the RMS voltage according to:
$${U}_{R M S} = \sqrt{\frac{1}{N} ( {\sum }_{i = 1}^{N} {V}_{i}^{2} )} ;$$
sampling and acquiring new voltage data points;
storing each newly acquired voltage data point in a storage stack;
managing the storage stack such that for each newly stored voltage point, the first of oldest stored voltage data point in the stack is removed such that the total number of measured points in the stack remains constant and equal to N; and
for each new sampled point, estimating the RMS voltage value with the new sample, according to
$${U}_{R M S} = \sqrt{\frac{1}{N} ( {\sum }_{i = 1}^{N} {V}_{i}^{2} )} ;$$
comparing the estimated RMS voltage U_{RMS} to a predetermined range of nominal values of voltage required/allowed; and
correcting voltage before a next half of the AC period by calculating a required value of reactive power needed to be connected to the electrical network to increase and/or decrease voltage in order to be in the range of nominal values required/allowed and connecting one or more reactive components with the required value of reactive power in parallel to the load before the beginning of the next half of the AC period, thereby correcting the voltage during less than a half of the AC period.

37. The method of claim 36, wherein N≥100 points and wherein the N points are equidistantly dispersed points of voltage Vi magnitudes during less than half of the AC period.

38. The method of claim 36, wherein the network is connected to a transmission and/or distribution line and is represented by an equivalent circuit which is connected to a voltage source providing a voltage signal Vs, and where a resistance R1 and a reactance X1 of the distribution line are connected in parallel and a resistance R2 and a reactance X2 of the load are connected in parallel;
wherein
$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} ;$$
wherein a voltage magnification coefficient is defined as
$$λ r = {( \frac{V o}{V s} )}^{2} and χ = \frac{V o}{V s} ,$$
where Vo is an output voltage.

39. The method of claim 38, wherein correcting voltage comprising:
estimating a required capacitance to be connected in parallel to the load, according to:
$$C = \frac{Yc}{ω}$$
wherein
$$Yc = \frac{1}{Xc}$$
and Xc is the reactance of the capacitance required to be connected, and ω is the base angular frequency of the voltage signal; and
connecting n capacitors in parallel to the load to provide the required capacitance C;
or
estimating a required inductance to be connected in parallel to the load, according to:
$${L}_{coil} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} - \frac{1}{{X}_{2}} ]} ,$$
wherein one or more additional power sources are connected to the electrical network for providing a supplementary electrical power P and wherein
$${G}_{P} = \frac{P}{{V}_{S}^{2}} ;$$
wherein
$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$
and ρ<1;
connecting 1 inductors in parallel to the load to provide the required inductance Lcoil.

40. The method of claim 39, wherein correcting voltage further comprising:
estimating a required capacitance, which brings to a maximal voltage increase, to be connected in parallel to the load, according to:
$${C}_{vmax} = \frac{{Y}_{1} + {Y}_{2}}{ω} ;$$
thereby providing information regarding the maximal voltage increase allowed.

41. The method of claim 39, wherein one or more additional power sources are connected to the electrical network for providing a supplementary electrical power P where
$${G}_{P} = \frac{P}{{V}_{S}^{2}} ,$$
and wherein P is sampled every m seconds, thereby allowing calculating the resistance R2 and the reactance X2 of the load;
wherein correcting the voltage comprising:
defining a parameter ρ, wherein
$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )} ,$$
and ρ>1;
determining parameter ρ according to the required voltage correction;
defining a parameter α wherein
$$α = \frac{{G}_{P}^{2}}{[ ( {G}_{1} + {G}_{2} ) {G}_{P} + 0.5 ( {G}_{1}^{2} + {Y}_{1}^{2} ) ]} ;$$
and
calculating α according to the determined ρ parameter.

42. The method of claim 41, wherein a source current Is is calculated according to:
$$Is = \sqrt{{( \frac{χV s}{R 2} - \frac{P}{χV s} )}^{2} + {V s}^{2} + {( \frac{χ}{X 1} - \frac{χ}{Xc} )}^{2}}$$
where Vs is the voltage of the AC voltage source, R₂ is the resistance of the load, P is the supplementary power of the additional power source, V₀ is the output voltage,
$$χ = \frac{V o}{V s}$$
and Xc is the reactance of a capacitance C connected to the load in parallel.

43. The method of claim 38, wherein a voltage control functionality is integrated into the electrical network to facilitate gradual voltage correction over a specified number of AC periods up to a moment the voltage returns to the nominal range of values, wherein correcting voltage further comprises:
upon correcting the voltage by the voltage control functionality, estimating required C and decreasing the capacitance accordingly, by disconnecting one or more capacitors from the n capacitors;
repeatedly estimating C as the voltage control functionality corrects the voltage and repeatedly decreasing the capacitance accordingly, by disconnecting one or more capacitors from the n capacitors, until the required capacitance is C=0 and all n capacitors are disconnected;
wherein the capacitors are connected to the load for about 40-150 seconds, thereby allowing the voltage control functionality to fully correct the voltage such that no capacitance is required to be connected to the load; and
wherein the capacitors are connected at the beginning or end of a voltage AC

44. The method of claim 36, wherein when correcting the voltage, connecting one or more capacitors to the load for increasing the voltage or connecting one or more inductors to the load for decreasing the voltage.

45. The method of claim 39, wherein a voltage control functionality is integrated into the electrical network to facilitate gradual voltage correction over a specified number of AC periods up to a moment the voltage returns to the nominal range of values;
wherein correcting voltage further comprises:
upon correcting the voltage by the voltage control functionality, estimating required Lcoil and decreasing the inductance accordingly, by disconnecting one or more inductors from the 1 inductors; and
repeatedly estimating Lcoil as the tap changer corrects the voltage and repeatedly decreasing the inductance accordingly, by disconnecting one or more inductors from the 1 inductors, until the required inductance is Lcoil=0 and all 1 inductors are disconnected;
wherein the inductors are connected to the load for about 40-150 seconds, thereby allowing the voltage control functionality to fully correct the voltage such that no inductance is required to be connected to the load;
wherein the inductors are connected and/or disconnected with switches; and
wherein the inductors are connected at the beginning or end of a voltage AC period.

46. A system for fast correction of voltage during less than a half of an AC period, comprising:
An AC voltage source providing a voltage signal with a frequency f;
a voltage transducer for translating instantaneous network voltage magnitudes to low voltage signals of up to 50 Volts;
an analog to digital converter (A/D) receiving input signals from the voltage transducer and outputs digital signals; and
a controller receiving the digital signals from the A/D, configured to:
measure and/or sample N points of voltage Vi of the AC voltage signal, during less than half of the AC period, each point is measured/sampled at a time tᵢ, where i=1 . . . N;
estimate a Root Mean Square (RMS) voltage during less than a half of an AC period, by:
calculating a correction coefficient Kc according to:
$${K}_{C} = \frac{1}{\sqrt{1 - \frac{sin ( 2 βπ )}{2 βπ}}} , β = ω {t}_{mes}$$
wherein β is a dimensionless coefficient, which is dependent on the total time measurement tₘₑₛ during which the N points are measured;
estimating the RMS voltage U_{RMS}, according to:
$${U}_{RMS} = {K}_{C} \cdot \sqrt{\frac{1}{N} {\sum }_{i = 1}^{N} {V}_{i}^{2}}$$
or
fitting the measured points by representation as a sum of first k-odd sinusoidal harmonics, by applying approximation of the measured points using Least-Mean-Square approach (LMS) according to the formula:
$$S = {\sum }_{i = 1}^{k} {[ {V}_{i} - {A}_{1} sin ( ω {t}_{i} ) - {A}_{3} sin ( 3 ω {t}_{i} ) - ⋯ - {A}_{2 k - 1} sin ( ( 2 k - 1 ) ω {t}_{i} ) ]}^{2} \to MIN$$
where S is an approximation criterion, A1, A3 . . . A₂ₖ₋₁ are amplitudes of the 2k−1-odd sinusoidal harmonics of the AC signal, ω is a base angular frequency of the voltage signal, and tᵢ is the time difference between two adjacent voltage measurements, and
wherein A₁, A₃ . . . A₂ₖ₋₁ are found to fulfill the minimal value of S that is found by solving a system of K-linear algebraic equations which can be represented in the matrix form as follows:
$$( \begin{matrix}{A}_{1} \\ {A}_{3} \\ ⋮ \\ {A}_{2 k - 1}\end{matrix} ) = {( \begin{matrix}{a}_{11} & {a}_{12} & ⋯ & {a}_{1 k} \\ {a}_{21} & {a}_{22} & ⋯ & {a}_{2 k} \\ ⋯ & ⋯ & ⋯ & ⋯ \\ {a}_{k 1} & {a}_{k 2} & ⋯ & {a}_{kk}\end{matrix} )}^{- 1} \cdot ( \begin{matrix}{U}_{1} \\ {U}_{2} \\ ⋮ \\ {U}_{k}\end{matrix} )$$
$$where :$$
$${U}_{i} = {\sum }_{i = 1}^{N} {V}_{i} sin ( ( 2 n - 1 ) \cdot ω {t}_{i} ) , n ∈ 1 , … , k$$
$${a}_{lm} = {\sum }_{i = 1}^{N} sin ( ( 2 l - 1 ) \cdot ω {t}_{i} ) \cdot sin ( ( 2 m - 1 ) \cdot ω {t}_{i} ) , l ∈ 1 , … , k ;$$
or
storing the Vᵢ values of the N sampled points representing each half of the entire AC period in a stack with the same N places;
estimating the RMS voltage according to:
$${U}_{RMS} = \sqrt{\frac{1}{N} ( {\sum }_{i = 1}^{N} {V}_{i}^{2} ) ;}$$
sampling and acquiring new voltage points;
storing each newly acquired voltage point in the stack;
managing the stack such that for each newly stored voltage point, the first of oldest stored voltage point in the stack is removed such that the total number of measured points in the stack remains constant and equal to N; and
for each new sampled voltage point, estimating the RMS voltage value with the new sampled voltage point, according to
$${U}_{RMS} = \sqrt{\frac{1}{N} ( {\sum }_{i = 1}^{N} {V}_{i}^{2} ) ;}$$
compare the estimated RMS voltage U_{RMS} to a predetermined range of values of voltage required/allowed; and
correct voltage before a next half of the AC period by calculating a required value of reactive power needed to be connected to the electrical network to increase and/or decrease voltage in order to be in the range of nominal values required/allowed, and connecting one or more reactive components with the required value of reactive power in parallel to the load before the beginning of the next half of the AC period, thereby correcting the voltage during less than a half of the AC period.

47. The system of claim 46, wherein the electrical network is connected to a transmission and/or distribution line and is represented by an equivalent circuit which is connected to a voltage source providing a voltage signal Vs, and where a resistance R1 and a reactance X1 of the distribution line are connected in parallel and a resistance R2 and a reactance X2 of the load are connected in parallel;
wherein
$${G}_{1} = \frac{1}{{R}_{1}} ; {Y}_{1} = \frac{1}{{X}_{1}} ; {G}_{2} = \frac{1}{{R}_{2}} ; {Y}_{2} = \frac{1}{{X}_{2}} ;$$
and
wherein a voltage magnification coefficient is defined as
$$λ r = {( \frac{V o}{V s} )}^{2} and χ = \frac{V o}{V s} ,$$
where Vo is an output voltage.

48. The system of claim 47, wherein the controller is configured to correct voltage by:
estimating a required capacitance to be connected in parallel to the load, according to:
$$C = \frac{Yc}{ω}$$
wherein
$$Yc = \frac{1}{Xc}$$
and Xc is the reactance of the capacitance required to be connected, and ω is the base angular frequency of the voltage signal, and
connecting n capacitors in parallel to the load to provide the required optimal capacitance C;
or by:
estimating a required inductance to be connected in parallel to the load, according to:
$${L}_{coil} = \frac{1}{ω [ \sqrt{ρ ( {G}_{1} + {G}_{2} ) {G}_{P} + 0.5 ( {G}_{1}^{2} + {Y}_{1}^{2} ) - {( {G}_{1} + {G}_{2} )}^{2}} - {Y}_{1} - \frac{1}{{X}_{2}} ]} ,$$
wherein one or more additional power sources are connected to the electrical network for providing a supplementary electrical power P and wherein
$${G}_{P} = \frac{P}{{V}_{S}^{2}} ;$$
wherein
$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$
and ρ<1; and
connecting n inductors in parallel to the load to provide the required inductance Lcoil.

49. The system of claim 48, wherein the controller is further configured to:
estimate a required capacitance which brings to a maximal voltage increase, to be connected in parallel to the load, according to:
$${C}_{vmav} = \frac{{Y}_{1} + {Y}_{2}}{ω} ,$$
thereby providing information regarding the maximal voltage increase allowed.

50. The system of claim 48, further comprising one or more additional power sources connected to the electrical network for providing a supplementary electrical power P where
$${G}_{P} = \frac{P}{{V}_{S}^{2}} ,$$
wherein P is sampled every m seconds, thereby allowing calculating the resistance R2 and the reactance X2 of the load.

51. The system of claim 50, wherein the controller is further configured to correct the voltage, by:
defining a parameter ρ, wherein
$$ρ = \frac{[ {( {G}_{1} + {G}_{2} )}^{2} + {( {Y}_{1} + {Y}_{2} - {Y}_{C} )}^{2} ]}{( {G}_{1} + {G}_{2} ) {G}_{P} + 0.5 ( {G}_{1}^{2} + {Y}_{1}^{2} )}$$
and ρ>1;
determine parameter ρ according to the required voltage correction;
defining a parameter α wherein
$$α = \frac{{G}_{P}^{2}}{[ ( {G}_{1} + {G}_{2} ) {G}_{P} + 0.5 ( {G}_{1}^{2} + {Y}_{1}^{2} ) ]} ;$$
and
calculating α according to the determined ρ parameter.

52. The system of claim 48, further comprising a voltage control functionality integrated into the electrical network to facilitate gradual voltage correction over a specified number of AC periods up to a moment the voltage returns at its nominal value, wherein correcting voltage further comprises:
upon correcting the voltage by the voltage control functionality, estimating required Lcoil and increasing the inductance accordingly, by disconnecting one or more inductors from the 1 inductors;
repeatedly estimating Lcoil as the tap changer corrects the voltage and repeatedly increasing the inductance accordingly, by disconnecting one or more inductors from the 1 inductors, until the required inductance is Lcoil=0 and all 1 inductors are disconnected.

53. The system of claim 47, further comprising a voltage control functionality to facilitate correcting the voltage gradually over a specified number of AC periods up to a moment the voltage returns at its nominal value, and wherein the controller is configured to:
upon correcting the voltage by the voltage control functionality, estimating required C and decreasing the capacitance accordingly, by disconnecting one or more capacitors from the n capacitors;
repeatedly estimating C as the voltage control functionality corrects the voltage and repeatedly decreasing the capacitance accordingly, by disconnecting one or more capacitors from the n capacitors, until the required capacitance is C=0 and all n capacitors are disconnected;
wherein the capacitors are disconnected with switches.

54. The system of claim 46, wherein the controller is configured to correct the voltage by:
connecting one or more capacitors to the load for increasing the voltage or connecting one or more inductors to the load for decreasing the voltage.
